(19) United States
(12) Patent Application Publication
(10) Pub. No.: US 2020/0281156 A1
(43) Pub. Date: Sep. 10, 2020

(54) Pet Animal Housing Unit With Safe Access To Grass On A Lawn

(71) Applicants: Stanley Yifei Liu, Warren, NJ (US); Wesley Yiming Liu, Warren, NJ (US); Zhiqiang Liu, Warren, NJ (US)

(72) Inventors: Stanley Yifei Liu, Warren, NJ (US); Wesley Yiming Liu, Warren, NJ (US); Zhiqiang Liu, Warren, NJ (US)

(21) Appl. No.: 16/389,960

(22) Filed: Apr. 21, 2019

Related U.S. Application Data
(63) Continuation-in-part of application No. 16/297,658, filed on Mar. 10, 2019.

(51) Int. Cl. A01K 1/03

(52) U.S. Cl. CPC A01K 1/03; A01K 1/035

(57) ABSTRACT

The present invention is a pet cage having an upper cage member and a lower base member. The lower base member has at least two portions: a fixed portion and one or more adjustable portions that can be extended or collapsed as needed. The fixed portion comprises multiple sidewalls arranged in serial to form an enclosed structure except for an opening on one or more sides, where a lip takes the place of a wall that would otherwise enclose the fixed portion of the fixed portion. One or more adjustable portions are located adjacent, and attached to the one or more sides of the fixed portion of the base member. While in a partially or fully extended state, the adjustable portions have fully open or partially open bottoms that provide access for the pet to reach fresh grass underneath the cage or to conveniently clean bedding material.

### CROSS-REFERENCE TO RELATED APPLICATIONS

This application is a continuation-in-part of U.S. non-provisional patent application Ser. No. 16/297,658 filed Mar. 10, 2019, entitled “Pet Animal Housing Unit With Safe Access To Grass On A Lawn.”

### FIELD OF INVENTION

The invention relates generally to improvements in animal housing units, and more particularly to animal enclosure construction that may be adjusted to provide an access point for caged pets to graze outdoors safely without leaving the safety of the housing unit.

### DESCRIPTION OF THE RELATED ART

Various types of cages have been developed to house indoor pets. For example, hamsters and guinea pigs are frequently confined in cages indoors. The cages come in various sizes, shapes and configurations.

U.S. Pat. No. 3,195,505 issued to F. C. Hauth et al. is an example of a small animal cage with a preset size and shape, the entire content of which is incorporated herein by reference thereto. The cage in Hauth comprises three main parts: an upper wire lattice portion forming the main enclosure, a grated or pervious floor portion, and a lower base portion. The grated or pervious floor portion is suspended above the floor of the lower base portion and serves to keep the animals away from its urine and droppings, which pass through the grated or pervious floor portion and land on the floor of lower base portion.

Hauth's three-part design is primarily tailored for the needs of laboratories. Cages designed for raising indoor pets typically do not contain a grated or pervious floor portion. Instead, the pet lives directly on the floor of the lower base portion. A layer of bedding is provided within the lower base portion to absorb the pet's urine and keep its droppings from contacting the lower base portion. The bedding is typically made of highly absorbent material, such as paper, wood chips, etc. and may further contain chemical substances for absorbing, neutralizing or masking undesirable odors from the pet.

The three-part or two-part (without the grated or pervious floor portion) designs continue to be the mainstream designs more than fifty years after Hauth was issued. Of course, many changes have been implemented without changing the overall design. Advancements in material sciences have led to the development of cheaper and more processable materials for manufacturing parts of the cage. For examples, metal has been replaced by plastic materials for making many parts, including the lower base portion. Additionally, cages with more than one level of platform have been developed, such as those described in U.S. Pat. No. 5,964,189 to Northrop et al., and U.S. Pat. No. 6,318,295 to Wade, the entirety of their contents is incorporated herein by reference thereto.

Another advancement in the design of pet cages is the development of expandable or collapsible cages. A conventional cage is designed such that its size and shape are preset at the time of the installation and cannot be adjusted during use. Expandable or collapsible cages are designed such that the cages can be expanded or collapsed depending on needs.

While there are several examples of cages with an adjustable size, most of them are portable cages used to transport animals. For example, U.S. Pat. No. 7,228,820 to Kellogg describes an expandable and collapsible portable cage that includes a pliable cover and a semi-rigid frame that can be adjusted for size. U.S. Pat. No. 5,054,426 to Panarelli describes an expandable enclosure for animals that includes two rigid shells. The rigid shells are slidably connected to a middle portion such that sliding the two rigid portions apart expands the enclosure accordingly. U.S. Pat. No. 5,960,744 to Rutman describes an expandable closure for animals including a first and a second compartments. Each of the compartments has an open end and a closed or closeable end. The compartments are positioned in telescoping relation providing a composite volume that includes both of the open ends, and a substantially liquid-tight seal between the compartments at the bottom is included.

While all of above-referenced patents provide for useful cages, they do not permit the pet inhabitant to graze on fresh grass outdoors. The caged pets are typically fed indoors using foods that are either purchased from stores or online. At feeding time, the caretaker would bring food into the cage and place it within the food container. The food is often purchased, such as dried grass cuttings, which adds cost to the caretaker.

Feeding pets with fresh grass that is grown on a lawn is an appealing concept for many pet owners for several reasons. First, the fresh grass is often readily available for several seasons in a year. Many households, especially those located in a rural or suburban areas, have lawns where fresh grass is grown during certain seasons each year. Second, using the fresh grass as a substitute for or supplement to purchased food reduces the cost of raising the pet. Third, many pets prefer to eat fresh grass from a lawn over purchased dry grass. If the pets are allowed to graze on fresh grass, it also would significantly reduce the workload borne by the caretakers.

Despite the appeals of feeding pets with fresh grass, many pet owners have chosen not to do it. This is because there have not been any convenient and safe methods for doing it. Taking the pet outside its cage and leaving it on the lawn often incur unacceptable level of risks. For example, eagles or hawks constantly circle the sky in certain rural areas, looking for preys. The pets may also escape from the lawn and venture into the wild or worse, traffic on the road. In light of these risks, many pet owners have chosen to collect fresh grass from outside, and then bring the grass indoors to feed the pets.

Known cage designs, including those described in the above patents, do not allow indoor pets to graze outdoors. Indoor pets living in these cages do not have access to grass when the cages are brought outside and placed on the lawn.

Therefore, there exists a need for a pet cage that can allow pets to safely reach fresh grass.

### BRIEF DESCRIPTION OF THE INVENTION

In a first embodiment of this invention, the pet cage comprises an upper cage member forming the main enclosure and a lower base member. The lower base member has a bottom and several sidewalls connected sequentially to enclose the bottom. An opening is created along the lower edge of a first sidewall and extends along the bottom toward the sidewall that opposes the first sidewall. Guides are provided along the edges of the opening for receiving and supporting an exchangeable plate. Exchangeable plates with different designs are provided, such as plates without any access points (e.g., through-holes), and plates with one or more access points. An exchangeable plate without any access point is used when access to grass is not desired, such as when the pet is housed indoors. A plate with one or more access points is used when access to grass is desired.

The second embodiment of the invention differs from the first embodiment in that guides are provided along the edges of the opening for receiving and supporting an exchangeable tray. Each exchangeable tray comprises two opposing sidewalls, a front plate, a bottom plate and preferably, a backplate. The exchangeable tray may be supported on the guides in different ways. For example, the bottom plate of an exchangeable tray may contact with and rest upon horizontally extending edges of the guides when the exchangeable tray is inserted into the opening. Alternatively, the top of the opposing sidewalls of the exchangeable tray may have horizontally extending lips or edges that may be perched on top the guides when the exchangeable tray is inserted into the opening. One or more exchangeable trays are provided with different bottom plate designs, such as a bottom plate without any access points or a bottom plate with one or more access points. An exchangeable tray with a bottom plate without any access points is used when access to grass is not desired, such as when the pet is housed indoors. An exchangeable tray with a bottom plate having one or more access points is used when access to grass is desired.

The third embodiment of the invention differs from the first embodiment in that guides are provided along the edges of the opening for receiving and supporting two or more exchangeable plates. When inserted into the opening, the exchangeable plates are placed substantially on top of each other and suspended at different heights from the bottom of the lower base member. Different exchangeable plates can be inserted as needed. For example, an exchangeable plate without any access points can be used above an exchangeable plate with one or more access points, when access to grass is not desired, such as when the pet is housed indoors. The top exchangeable plate can be removed when access is desired.

The fourth embodiment of the invention differs from the first embodiment in that the edge portions of the exchangeable plate have channels defined therein for receiving the corresponding edge portions of the opening in the bottom of the lower base member. In this design, no guides are needed along the edges of the opening of the lower base member. Exchangeable plates with different designs are provided, such as plates without any access points (e.g., through-holes), and plates with one or more access points. An exchangeable plate without any access point is used when access to grass is not desired, such as when the pet is housed indoors. An exchangeable plate with one or more openings is used when access to grass is desired.

A fifth embodiment, as illustrated in FIGS. 13 through 19, is directed to a construction that has at least two portions for its base member: a fixed portion and one or more adjustable portions that can be extended or collapsed as needed. Instead of providing access points at the bottom surface of the base member, which is essentially the fixed portion in its entirety, as described in the preceding embodiments, or in addition to such access points that are located in the fixed portion, access points are provided by one or more adjustable portions that are located adjacent, and attached to one or more sides of the fixed portion of the base member. Each of the adjustable portions can alternate between a fully extended, partially extended, and fully collapsed state. The adjustable portions have fully open or partially open bottoms that provide access. When in the partially or fully extended state, access to grass is provided at the bottoms of the adjustable portions.

### BRIEF DESCRIPTION OF THE DRAWINGS

The invention will be understood more readily from the following detailed description of the invention, when taken in conjunction with the accompanying drawings.

FIG. 1 is a view in elevation and partially in section of a pet cage in accordance with a first embodiment of the invention, wherein the pet cage is in a fully assembled state.

FIG. 2 is a perspective view of a pet cage in accordance with the first embodiment of the invention, wherein the pet cage is in an expanded state.

FIG. 3 is a greatly enlarged view in elevation and in section showing a portion of the upper grille section of the pet cage of FIG. 1.

FIG. 4 is a greatly enlarged view of the parts in FIG. 1 that are surrounded by 4-4.

FIG. 4A is a greatly enlarged view in perspective showing in detail a connecting hook member 30 in accordance with the first embodiment of the invention.

FIG. 5 is a greatly enlarged cross-sectional view of a portion of the lower base member surrounded by 5-5 in FIG. 1, and indicated by 5-5 in FIG. 2.

FIG. 5A is a top view of the parts shown in FIG. 5, as indicated by 5A-5A.

FIG. 5B is a first alternative design for the guide 50A as shown in FIG. 5.

FIG. 5C is a second alternative design for the guide 50A as shown in FIG. 5.

FIG. 6A is a top view of the body portion of an exchangeable plate without any access point in accordance with the first embodiment of the invention.

FIG. 6B is a top view of the body portion of an exchangeable plate having multiple small circular access points in accordance with the first embodiment of the invention.

FIG. 6C is a top view of the body portion of an exchangeable plate having two large circular access points in accordance with the first embodiment of the invention.

FIG. 6D is a top view of the body portion of an exchangeable plate having a rectangular access point in accordance with the first embodiment of the invention.

FIG. 7 is a perspective view of an exchangeable tray in accordance with a second embodiment of the invention.

FIG. 8 is a cross-sectional view of the exchangeable tray in FIG. 7 that is cut along the line 8-8 as the exchangeable tray engages with the lower base member.

FIG. 9 is a cross-sectional view of an exchangeable tray as the tray engages with the lower base member in accordance with an alternative design of the second embodiment of the invention.

FIG. 10 is a cross-sectional view of a portion of the lower base member in accordance with a third embodiment of the invention.

FIG. 11 is a cross-sectional view of a portion of the lower base member in accordance with a fourth embodiment of the invention.

FIG. 12 is a perspective view of a pet cage having a lower base member, a sidewall enclosure, and a lid with a trapezoidal cross section.

FIG. 13 is a perspective view of a pet cage in accordance with a fifth embodiment of the invention wherein the adjustable portion is substantially in a collapsed state.

FIG. 13A is a perspective view of a pet cage in accordance with a fifth embodiment of the invention wherein the adjustable portion is in a partially extended state.

FIG. 13B is a perspective view of a pet cage in accordance with a fifth embodiment of the invention wherein the adjustable portion is in a fully extended state.

FIG. 14 is a top view of the lower base member along the cut-line shown as 14-14 in FIG. 13.

FIG. 14A is a top view of the lower base member along the cut-line shown as 14A-14A in FIG. 13A.

FIG. 14B is a top view of the lower base member along the cut-line shown as 14B-14B in FIG. 13B.

FIG. 15 is a front view of the lower base member as shown by the arrow 15 in FIG. 14.

FIG. 15A is a front view of the lower base member as shown by the arrow 15A in FIG. 14A.

FIG. 15B is a front view of the lower base member as shown by the arrow 15B in FIG. 14B.

FIG. 16 is a cross-sectional, front view of the fixed portion of the base member along the cut line 16-16 as shown in FIG. 14.

FIG. 17 is a side view of the adjustable portion of the base member viewed from a cross-sectional line 17-17 in the fixed portion of the base member as shown in FIG. 14.

FIG. 17A is a side view of the adjustable portion of the base member viewed from a cross-sectional line 17A-17A in the fixed portion of the base member as shown in FIG. 14A.

FIG. 17B is a side view of the adjustable portion of the base member viewed from a cross-sectional line 17B-17B in the fixed portion of the base member as shown in FIG. 14B.

FIG. 18 is a plan view of a conventional butt hinge that can be used as a fastening means for the fifth embodiment, as indicated by the call-out box 18 in FIGS. 15B and 19.

FIG. 19 is a perspective view of a hinge and its surrounding members as shown by the arrow 19 in FIG. 14B.

### DETAILED DESCRIPTION OF THE INVENTION

The invention is explained in connection with the following exemplary embodiments. They are provided as examples to facilitate the description of the invention and should not be regarded as exclusive embodiments. As discussed below, multiple variations can be made to the design of the cage without departing from the spirit or scope of the invention.

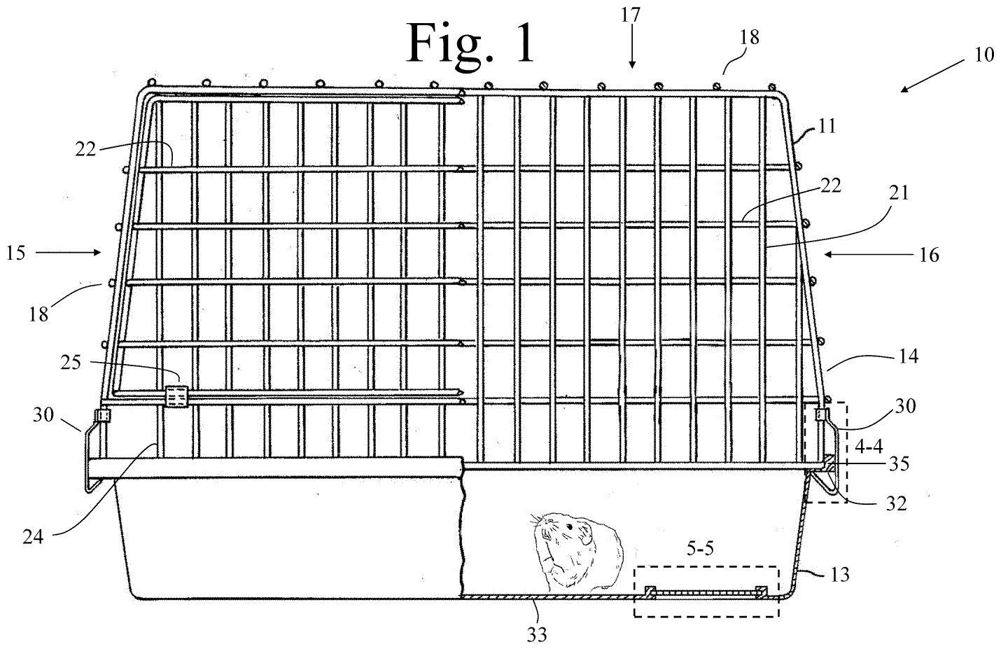

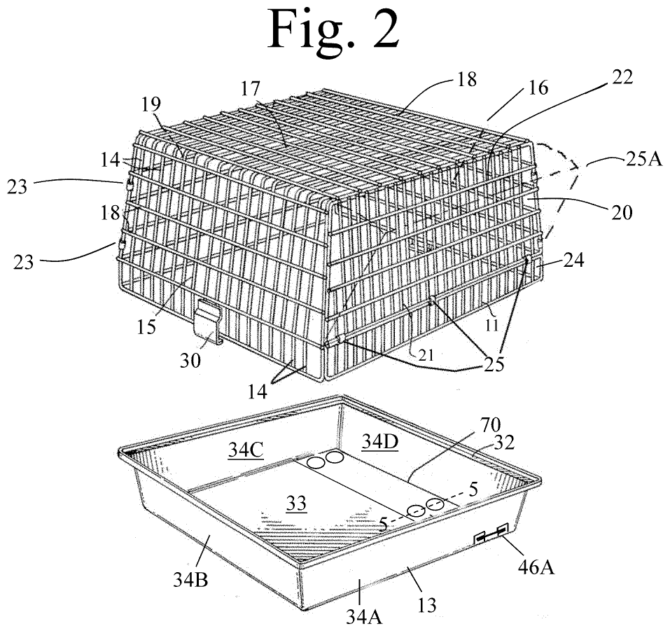

The first embodiment of the invention is illustrated in FIGS. 1 through 6D. FIG. 1 shows a pet cage 10 as it appears when fully assembled and in use indoors. The cage 10 comprises two major components, namely, an upper cage member 11 and a lower base member 13, which are shown in a detached state in FIG. 2. Both components preferably have a frusto-pyramidal configuration, although other configurations, such as a cube, rectangular prism, or another geometric shape may also be used without departing from the spirit or scope of this invention.

As shown in FIGS. 1 and 2, the upper cage member 11 of the cage 10 is preferably made from a plurality of rigid wire members which are preformed and joined together to form a mesh enclosure of the desired size. The mesh enclosure enables the following: air exchange between the pet cage and the environment, ambient light to reach the pet, the caretaker to see inside the cage and observe the pet, and the pet to see outside the cage. A central portion of the upper cage member 11 is formed by a series of inverted generally U-shaped and spaced apart wire members 14. The wire members 14 form opposite side members 15 and 16 and a roof portion 17. A series of spaced apart horizontal wires 18 are provided on the side members 15 and 17 and the roof portion 17. The wires 18 extend across and are joined to the wire members 14 (preferably at a 90 degree angle) to form the mesh pattern of this central section. The other sides of the upper cage member 11 are formed by separate upright side members 19 and 20, which are formed from a series of vertical wire members 21 and horizontal wire members 22. The side member 19 is fixed to the central portion of the upper cage member 11 between the sides 15 and 16 by clips or bands 23 that extend around the edge wire members of both the central member and the side member 19. The other side member 20 is hinged to a horizontal frame member 24, which is connected to the opposite sides 15 and 16 near the bottom edge of the upper cage portion 11, by a series of clips or bands 25 so that it can pivot thereon and provide a door 25A for the cage.

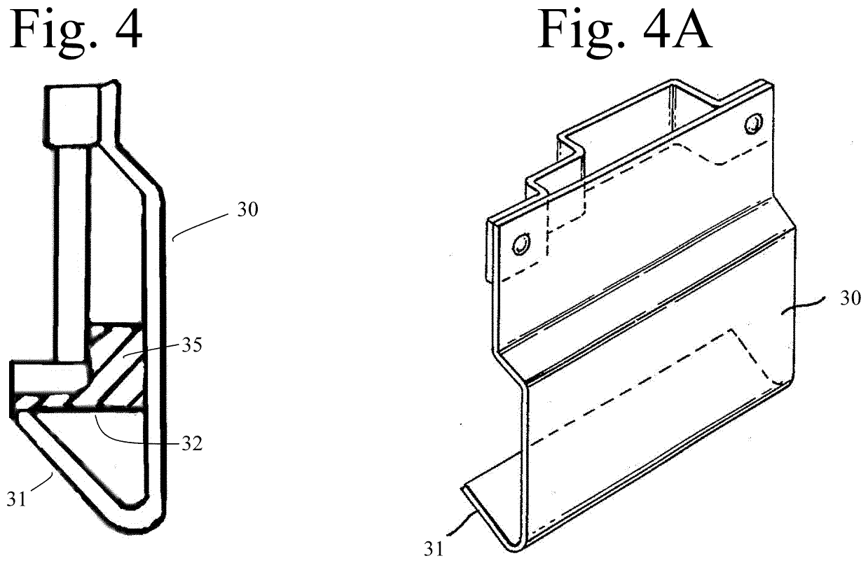

As shown in FIGS. 1 and 2, the lower base member 13 is where the pet, such as our guinea pig, Cinnamon, as depicted in FIG. 1, resides. The lower base member 13 is made from a sheet material and has a generally rectangular bottom 33 and a frusto-pyramidal shape formed by upwardly divergent sidewalls 34A, 34B, 34C and 34D. The bottom 33 can also be shaped other than a rectangle or a square, in which case, multiple sidewalls are provided to fully enclose the bottom 33. Instead of extending in an upwardly divergent manner, the sidewalls can also extend upwardly with a straight angle relative to the bottom 33. In either case, the sidewalls are connected in serial, i.e., one after another along shared edges (e.g., 34A to 34B, 34B to 34C, 34C to 34D, 34D to 34A), to form an enclosure. The enclosure has a top perimeter and a bottom perimeter. Around the top perimeter is a horizontally extending edge flange portion 32 of uniform width. The horizontally extending edge flange portion 32 is connected at its outer edge to an upwardly extending edge portion 35 (see FIG. 4). The top perimeter is adapted to receive the upper cage member 11 as discussed below. The bottom perimeter meets with the perimeter of the bottom 33 so that the enclosure and the bottom 33 are of an integral construction or separately formed but joined to each other.

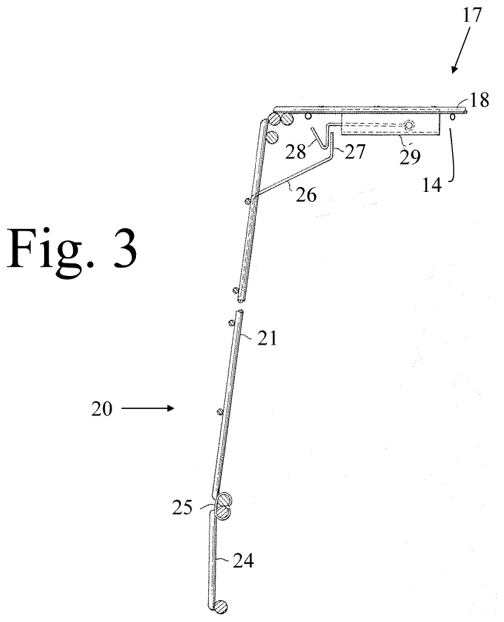

FIG. 3 illustrates a portion of the upper cage member 11 that is designed for regulating the door 25A. The door 25A is controlled by a latch 26 and a catch member 29. The latch 26 is provided on the side member 20 and comprises a resilient sheet member with a bent end flange 27. The catch member 29 is fixed to the roof portion 17 and comprises an end hook 28. The latch 26 is adapted to interact with the end hook 28, and when it fits behind the end hook 28, the interaction will keep the door 25A in a closed state. When the door 25A moves from an open position toward a closed position, the bent end flange 27 first touches the front (left) side of the end hook 28. Further movement of the door 25A will deform latch 26 and the bent end flange 27, effectively causing the bent end flange 27 to move downward, and at the same time, the end hook 28 deforms and moves upward. When the bent end flange 27 moves past the end hook 28 and comes into contact with its back (right) side, the latch 26, the bent end flange 27 and the end hook 28 will return to their undeformed state with the bent end flange 27 securely resting on the back side of the end hook 28 to keep the door 25A in the closed position. To open the door 25A, the end hook 28 is pushed upward, and/or the latch 26 and the bent end flange 27 are pushed downward. At this time, the end hook 28 and the bent end flange 27 will disengage, allowing the door 25A to be opened.

FIGS. 4 and 4A provide detailed views of the connecting hook member 30 and the top perimeter of the enclosure formed by the sidewalls of the lower base member, as shown in FIGS. 1 and 2. The connecting hook member 30 is provided on one or more sides of the cage for releasably connecting the upper cage member 11 and the lower base member 13. The connecting hook member 30 is formed from resilient sheet material. At its upper end, the connecting hook member 30 is adapted to releasably connect to some vertical and/or horizontal wire members in the upper cage member 11. The upper end can be designed as shown in FIG. 4A, or can be a simple tab (such as the lower lip portion 31) that engages a horizontal wire member in the upper cage member 11. At its lower end, the connecting hook member 30 is adapted to releasably connect to the lower base member 13. This is achieved by incorporating an inwardly and upwardly extending lower lip portion 31 that is adapted to fit around and under the horizontally extending edge flange portion 32 on the lower base member 13.

When the upper cage member 11 and the lower base member 13 are connected by one or more connecting hook members 30, the horizontally extending edge flange portion 32 directly supports the weight of the upper cage member 11 and passes the weight downward into the sidewalls, and the upwardly extending edge portion 35 forms an enclosure around the lower edge of the upper cage member 11 to prevent the upper cage member 11 from moving laterally in relation to the lower base member 13. When all hook members 30 are removed, the upper cage member 11 and the lower base member 13 can be separated.

As shown in FIGS. 1 and 2, the lower base member 13 is partially cut out in at least one sidewall as well as in the bottom to permit the pet to access grass when needed. The sidewall 34A of the lower base member is partially cut out, creating a side opening 46A at a location where the sidewall 34A meets the bottom 33.

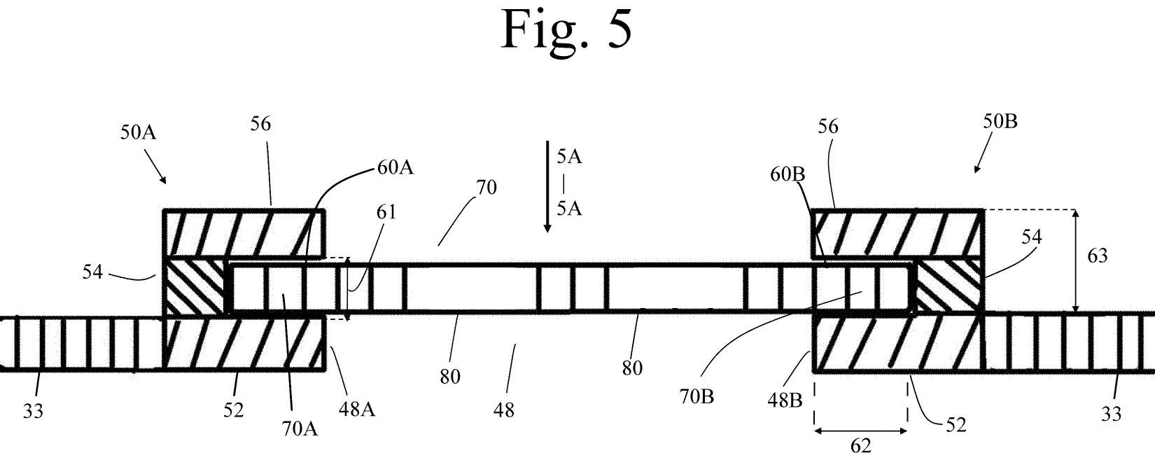

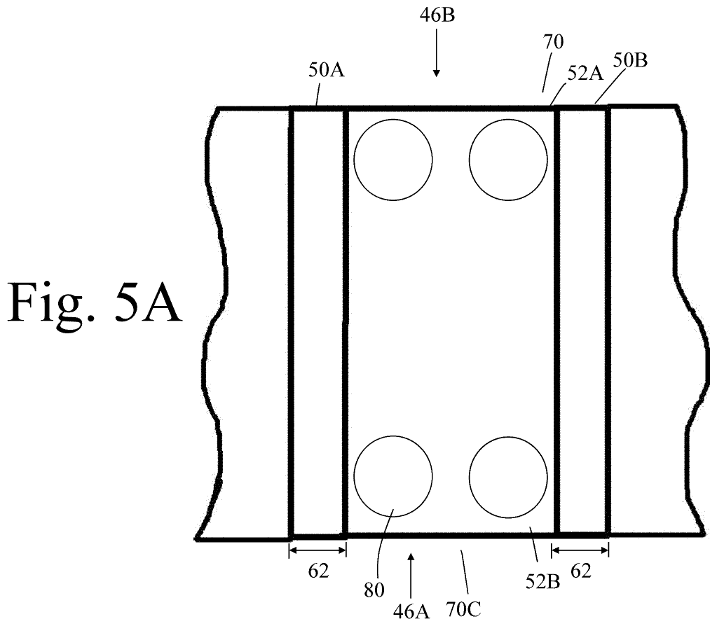

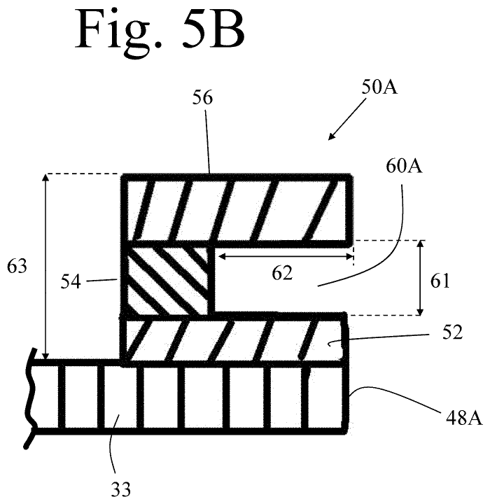

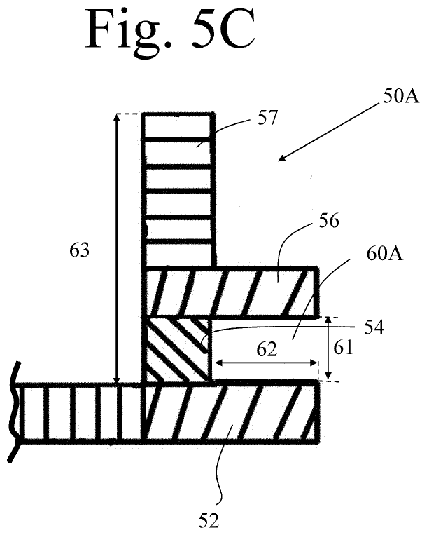

FIG. 5 is a cross-sectional view of a portion of the bottom of the lower base member 11, where access points are provided (as indicated by 5-5 in FIGS. 1 and 2). As shown in FIG. 5, the bottom 33 of the lower base member 13 is partially removed, creating a bottom opening 48 that is defined by the gap between two opposing edges 48A and 48B on the bottom 33. The edges 48A and 48B preferably run parallel to each other. The bottom opening 48 has a first end and a second end. On the first end, the bottom opening 48 connects with the side opening 46A. In the direction of the second end, the bottom opening 48 runs through the interior of the bottom 33 away from the sidewall 34A, preferably in a direction that is perpendicular to the sidewall 34A. The bottom opening 48 may extend partially or the entire distance to the sidewall 34C, which is directly or substantially opposite to the sidewall 34A. If the bottom opening 48 reaches the sidewall 34C, it may terminate as it reaches the sidewall 34C, leaving the sidewall 34C intact. Alternatively, the bottom opening 48 may terminate as a side opening 46B on the sidewall 34C, which mirrors the side opening 46A on the sidewall 34A.

A guide 50A is provided adjacent and along the edge 48A of the bottom opening 48. Similarly, a guide 50B is provided adjacent and along the edge 48B of the bottom opening 48. Each guide runs the entire length of the bottom opening 48 (i.e., from the first end to the second end of the bottom opening 48), and has bottom, side and top portions identified as 52, 54, and 56, respectively. The portions 52, 54 and 56 are preferably formed as a unitary structure. They also can be formed as separate elements and then assembled using any conventional means, such as using a glue or a fastener (screws, bolts/nuts, etc.). The bottom portion 52 can merge into the bottom 33 adjacent to the edges 48A and 48B (as shown in FIG. 5), or can be a separate element placed on top and attached to the bottom (as shown in FIG. 5B). In the latter case, the bottom portion 52 can be attached to the bottom by any conventional means, for example, by forming them as a unitary structure using a mould or forming them as separate elements that are connected using a glue or a fastener (screws, bolts/nuts etc.). The middle portion 54 projects away from the bottom 33 in the direction of the upper cage member 11. The top portion 56 is placed on top and connected to the middle portion 54, and runs substantially parallel to the bottom 33.

The bottom, middle and top portion (52, 54 and 56) along each edge (48A or 48B) cooperate to define a recessed space (60A or 60B) for engaging an exchangeable plate 70. The recessed space (60A or 60B) has a length, a height 61, and a depth 62. The length of the recessed space is the same as the length of the guide, and the length of the bottom opening 48. The guides are preferably dimensioned such that at its highest point, the distance 63 from the bottom 33 is similar to or more than the depth of bedding that is typically used for the pet cage. For example, the distance 63 can be about 1 to 3 inches, and preferably about 2 inches. If necessary, the top portion 56 may possess an element 57 that extends away from the bottom 33 so as to create the desired distance 63 (see FIG. 5C).

As shown in FIGS. 5 and 5A, an exchangeable plate 70 is provided to regulate the pet's access to grass. The exchangeable plate 70 has two edge portions (70A and 70B) for engaging with the corresponding recessed space (60A or 60B), and a body portion 70C. The surfaces of the edge portions 70A and 70B and the matching surfaces of the recessed space 60A and 60B can be smooth surfaces. Alternatively, these surfaces can modified to enhance friction when the edge portions 70A and 70B and the surface of the recessed space 60A and 60B are engaged with each other. The surfaces can be modified (e.g., roughened) using any conventional means, such as those disclosed in U.S. 2008/0038453 to Atsushi Yusa et al., DE19729891A1 to Hartmut Sauer, U.S. Pat. No. 5,826,586 to Ajit K. Mishra et al., and EP0875360A2 to Herbert Horn, et al, which are incorporated herein. As a further alternative, the edge portions 70A and 70B may be adapted to releasably engage with the recessed space 60A and 60B using the locking pin and detent hole combination as taught in U.S. Pat. No. 4,966,020 to Scott M. Fotheringham et al. (see e.g., column 5, lines 34-46, FIGS. 5-7), which is incorporated herein. In this design, one or more locking pins will be placed in each of the edge portions 70A and 70B, and detent holes are created in matching locations in the top portion 56 of the guides 50A and 50B.

The length of the exchangeable plate 70 is substantially the same as the length of the bottom opening 48 from the latter's first end to the second end. The width of the body portion 70C of the exchangeable plate 70 is substantially the same as the width of the bottom opening 48, i.e., the gap between 48A and 48B. The width of the edge portions 70A and 70B is substantially the same as the depth 62 of the recessed space 60A and 60B. The thickness of the edge portions 70A and 70B of the exchangeable plate 70 is substantially the same as the height 61 of the recessed space 60A or 60B. The body portion 70C may have the same or a different thickness as that of the edge portions 70A and 70B.

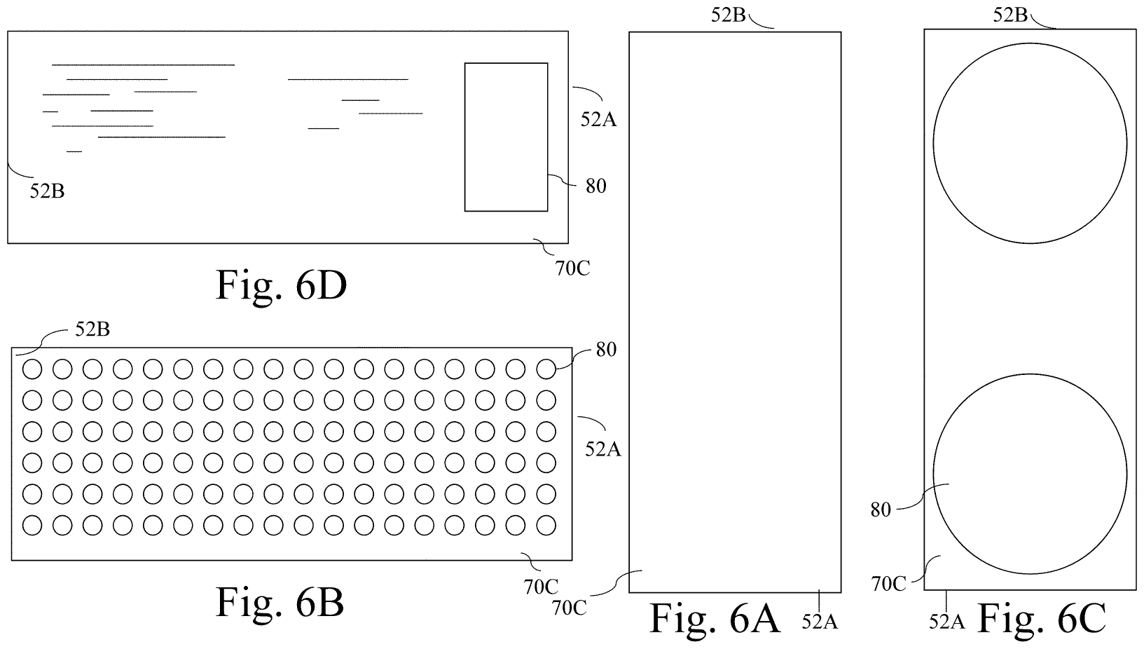

The body portion 70C of the exchangeable plate 70 can be designed in multiple formats for use under different situations. For example, in a first design (FIG. 6A), the plate does not have any access points, which is used when access to grass is not desired. In other designs (FIGS. 6B, 6C and 6D), the plate can have one or more access points (e.g., through-holes 80). When the pet cage is placed on the lawn, the pet can access the grass through the through-holes 80. The holes can be in any suitable size and geometric shapes, including circular, oval-shaped, star-shaped, rectangular, square, etc.

The exchangeable plate 70 can be readily installed on or removed from the lower base member 13. To install an exchangeable plate, the caretaker would insert a first end (52A, see FIG. 5B) of the exchangeable plate 70 into the side opening 46A on the lower base member 13, with the edges 70A and 70B inserted into the corresponding recessed space 60A and 60B. The caretaker would then continue pushing the plate into the interior of the bottom 33 until the exchangeable plate 70 is fully inserted, at which point 70C substantially covers up the entire bottom opening 48. As fully inserted, the second end 52B of the exchangeable plate 70 abuts the side opening 46A. The first end 52A of the exchangeable plate 70 abuts the inside of the opposing sidewall 34C or, if a side opening 46B is provided on the side wall 34C, the side opening 46B. To remove a plate, the caretaker would pull the plate toward either the side opening 46A or 46B until the plate is completely disengaged from the lower base member 13.

Gripping means are provided on the exchangeable plate 70 to facilitate the insertion or removal by hand. The gripping means can be depressions or small through-holes formed into the underside of the exchange plate 70 for receiving fingers. The gripping means can also be loops, rings, handles, knobs, bars and/or lips formed into or attached to the ends 52A and/or 52B.

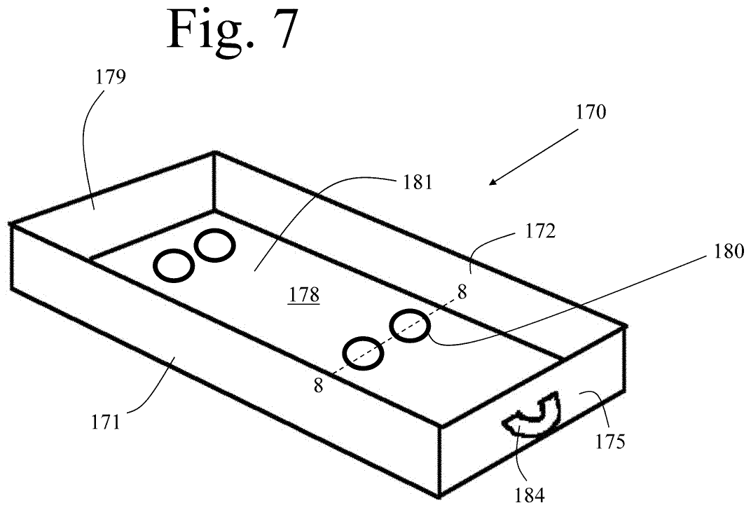

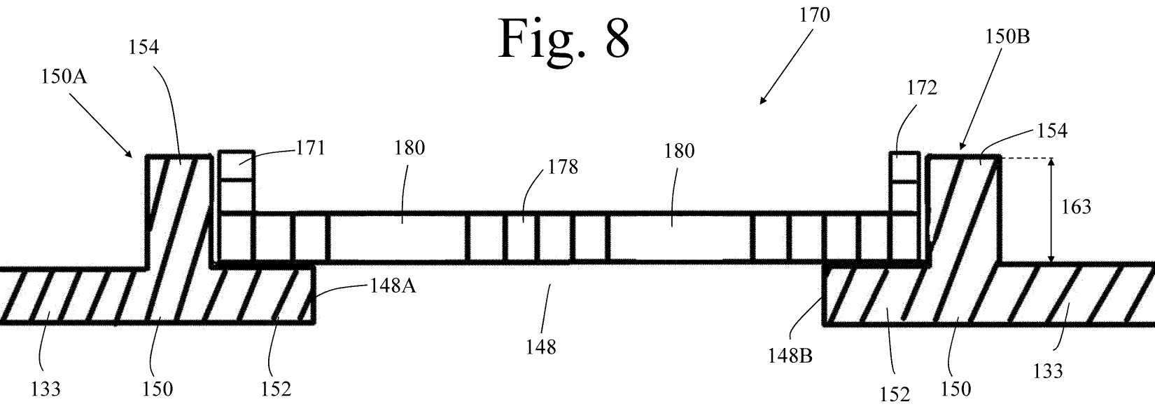

The second embodiment, illustrated in FIGS. 7 and 8, is identical with the first embodiment except that the exchangeable plate is replaced with an exchangeable tray with necessary modifications made to the guides so that they can effectively engage with the tray.

FIG. 7 is a perspective view of an exchangeable tray in accordance with this embodiment. The exchangeable tray 170 has two opposing sidewalls 171 and 172, a front plate 175, and a bottom plate 178. The exchangeable tray preferably further has a backplate 179. The sidewalls and plates 171, 172, 175, 178 and 179 share commons edges where they meet and together, they define an interior space 181 that is substantially a rectangular prism. Attached to the front plate 175 is a means 184 for pulling the tray 170 out of the lower base member when needed. Such means can be any of the conventional designs, such as one or more finger-receiving recesses, loops, rings, handles, knobs, bars and/or lips.

Similar to FIG. 5 in the first embodiment, FIG. 8 is a cross-sectional view showing an opening 148 in a part of the bottom 133 of the lower base member, and the exchangeable tray 170 that is adapted to engage with the opening 148 (see cut line 8-8 in FIG. 7). The opening 148 extends in a width direction between two opposing edges 148A and 148B, and extends in a length direction from a side opening on a first sidewall to the interior of the bottom 133, preferably reaching a second sidewall that is opposed to the first sidewall, and optionally terminating at a side opening on the second sidewall. Guides 150A and 150B are provided adjacent to each of the edges 148A and 148B to engage with the exchangeable tray 170. The guides 150A and 150B extend in a length direction that is substantially along the length direction of the edges 148A and 148B. Each guide has substantially an “L” shaped cross section, comprising a horizontal portion 152 and a vertical portion 154. The horizontal portion 152 can merge into the bottom 133 adjacent to the edges 148A and 148B (as shown in FIG. 8), or it can be a separate element placed on top and attached to the part of the bottom 133 immediately adjacent to the edges (similar to how 52 is separate from and joined to 33 in FIG. 5B). The vertical portion 154 extends from the bottom 133 of the lower base member for a distance 163 that is similar to or more than the depth of the bedding that is typically used for the pet cage. Similar to what is described above, the distance 163 is about 1 to 3 inches, and preferably about 2 inches.

When the exchangeable tray 170 is placed into the side opening 146A in a sidewall and further into the opening 148 in the bottom 133 of the lower base member, the undersides of the exchangeable tray that are located directly under the sidewalls 171 and 172 come into contact with and rest on top of the horizontal portion 152.

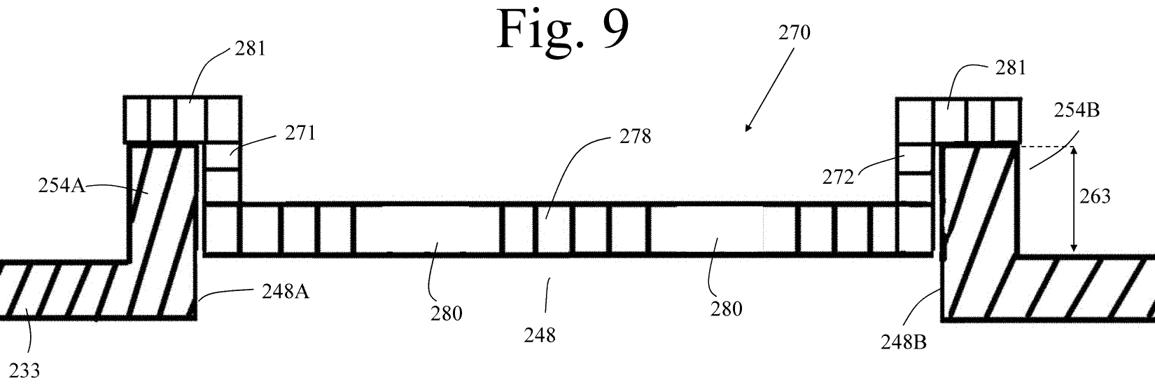

The exchangeable trays can also be designed to engage with the bottom of the lower base member in a different manner. Similar to FIG. 8, FIG. 9 is a cross-sectional view showing an opening 248 of the bottom 233 of the lower base member, and an exchangeable tray 270 that is adapted to engage with the opening 248. The opening 248 extends in a width direction between two opposing edges 248A and 248B, and extends in a length direction from a side opening on a first sidewall to the interior of the bottom 233, preferably reaching a second sidewall that is opposed to the first sidewall, and optionally terminating at a side opening on the second sidewall. Guides 254A and 254B are provided adjacent to the edges 248A and 248B. The guides 254A and 254B extend in a length direction that is substantially along the length direction of the edges 248A and 248B. The guides 254A and 254B extend in a height direction for a distance 263 from the inner surface of the bottom 233. The distance 263 is similar to or more than the depth of the bedding that is typically used for the pet cage. Similar to what is described above, the distance 263 is about 1 to 3 inches, and preferably about 2 inches.

The exchangeable tray 270 has two opposing sidewalls 271 and 272, a front plate 275, and a bottom plate 278, and preferably further has a backplate 279. The exchangeable tray 270 has a lip 281 on top of the sidewalls 271 and 272. The lip 281 extends from the sidewalls 271 and 272 horizontally and outwardly in relation to the interior space of the exchangeable tray 270. When the exchangeable tray 270 is inserted into the opening 248, the underside of the lip 281 comes into contact with the top surface of the guides 254A and 254B, thereby supporting the weight of the exchangeable tray 270 on the bottom 233 of the lower base member.

Similar to the body portion 70C in the first embodiment, the bottom plate 178/278 can have various designs, including those with or without access points (similar to what are shown in FIGS. 6A through 6D). When the cage is kept indoors, an exchangeable tray without any access points (e.g., through-holes) is placed inside the lower base member. When the cage is moved outdoors for access to fresh grass, an exchangeable tray with one or more access points is placed inside the lower base member.

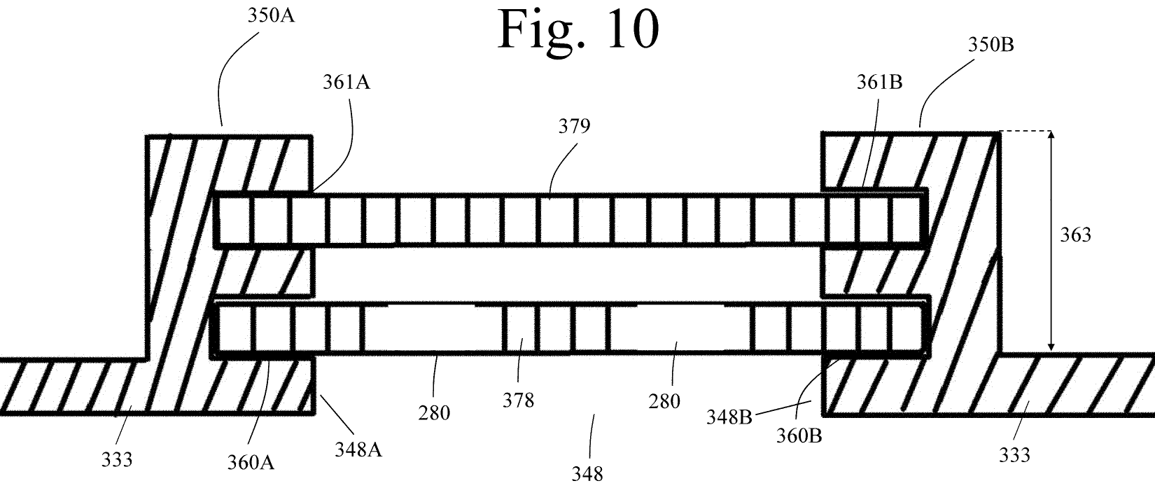

The third embodiment, illustrated in FIG. 10, is substantially identical with the first embodiment except that the guides are modified to accommodate two or more exchangeable plates. Similar to FIG. 5 in the first embodiment, FIG. 10 is a cross-sectional view showing an opening 348 in a part of the bottom 333 of the lower base member, and two exchangeable plates 378 and 379 that are adapted to engage with the opening 348. The opening 348 extends in a width direction between two opposing edges 348A and 348B, and extends in a length direction from a side opening on a first sidewall to the interior of the bottom 333, preferably reaching a second sidewall that is opposed to the first sidewall, and optionally terminating at a side opening on the second sidewall. Two “F”-shaped guides 350A and 350B are provided adjacent edges 348A and 348B. The guides 350A and 350B extend in a length direction that is substantially along the length direction of the edges 348A and 348B. The guides 350A and 350B extend in a height direction for a distance 363 from the inner surface of the bottom 333. The distance 363 is similar to or more than the bedding that is typically used for the pet cage. Similar to what is described above, the distance 363 is about 1 to 3 inches, and preferably about 2 inches.

The body portion of the exchangeable plates 378 and 379 can be designed according to the first embodiment. See FIGS. 6A through 6D. For example, the exchangeable plate 378 (the lower plate) may be a plate with one or more access points (e.g., through-holes) in its body portion, and the exchangeable plate 379 (the upper plate) may be a plate with no access points in its body portion. When the cage is indoors, both exchangeable plates can be inserted inside the cage as shown in FIG. 10. The exchangeable plate 379 presents an uninterrupted upper surface that can hold the bedding material or otherwise be available to the pet as a walking surface. When the cage is outdoors and access to fresh grass is desired, the exchangeable plate 379 is removed, exposing the exchangeable plate 378 to the pet. The pet can access fresh grass through the holes in the exchangeable plate 378. Once grass feeding is completed, the exchangeable plate 379 can be replaced, recreating the uninterrupted surface.

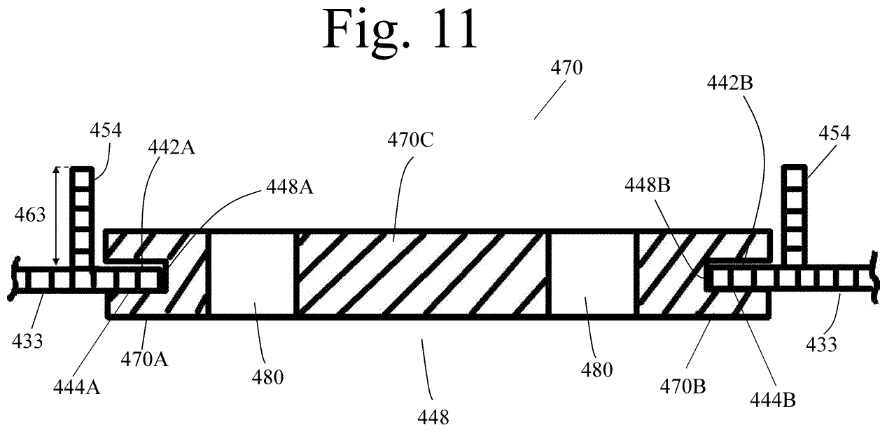

The fourth embodiment, illustrated in FIG. 11, is substantially identical with the first embodiment except that the exchangeable plate has two edge portions, each of which has a channel defined therein for engaging with an edge portion of the bottom of the lower base member adjacent to the opening. Similar to FIG. 5 in the first embodiment, FIG. 11 is a cross-sectional view showing an opening 448 in a part of the bottom 433 of the lower base member, and an exchangeable plate 470 with two edge portions 470A and 470B having channels 442A and 442B defined therein. The opening 448 extends in a width direction between two opposing edges 448A and 448B, and extends in a length direction from a side opening on a first sidewall to the interior of the bottom 433, preferably reaching a second sidewall that is opposed to the first sidewall, and optionally terminating at a side opening on the second sidewall. The opposing edges 448A and 448B are the side edges of edge portions 444A and 444B of the bottom 433. The edge portions 470A and 470B of the exchangeable plate, and the channels 442A and 442B extend in a length direction that is substantially along the length direction of the edges 444A and 444B. Barrier members 454 are provided on the bottom 433 adjacent to the edge portions 444A and 444B, and extend in a length direction that is parallel to the edge portions 444A and 444B. The barrier members extend in a height direction for a distance 463 from the inner surface of the bottom 333. The distance 463 is similar to or more than the bedding that is typically used for the pet cage. Similar to what is described above, the distance 463 is about 1 to 3 inches, and preferably about 2 inches. The body portion 470C of the exchangeable plate 470 can be designed according to the first embodiment. See FIGS. 6A through 6D. For example, the body portion 470C may have access points, such as through-holes 480.

The exchangeable plate 470 can be readily installed on or removed from the lower base member. To install an exchangeable plate, the caretaker would insert a first end 452A of the exchangeable plate 470 into the side opening 446A on the lower base member, with the edges 444A and 444B of the bottom 433 inserted into the corresponding channels 442A and 442B of the exchangeable plate. The caretaker would then continue pushing the plate into the interior of the bottom 433 until the exchangeable plate 470 is fully inserted, at which point 470C substantially covers up the entire bottom opening 448. As fully inserted, the second end 452B of the exchangeable plate 470 abuts the side opening 446A. The first end 452A of the exchangeable plate 470 abuts the inside of the opposing sidewall 434C or, if a side opening 446B is provided on the side wall 434C, the side opening 446B. To remove an exchangeable plate, the caretaker would pull the plate toward either the side opening 446A or 446B until the exchangeable plate is completely disengaged from the lower base member.

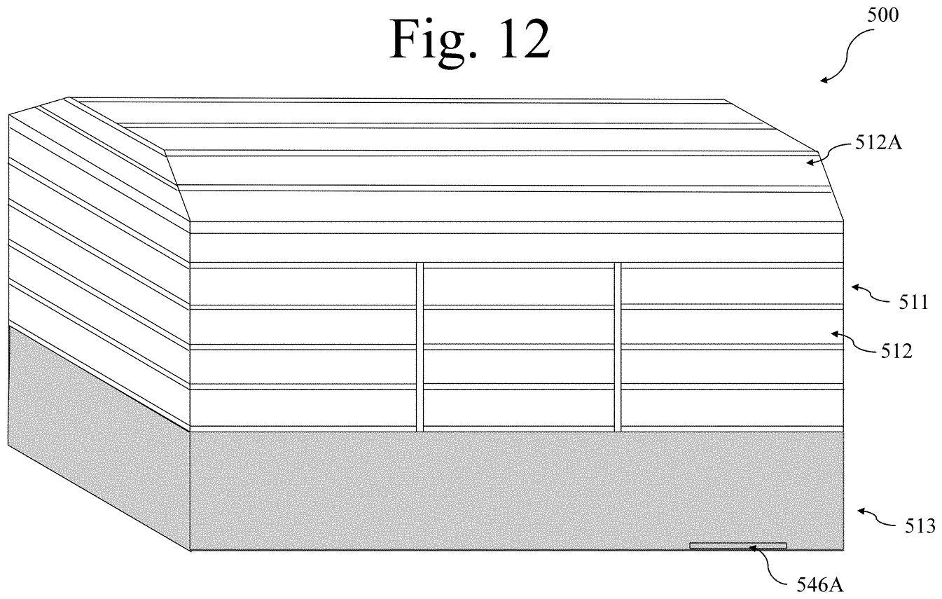

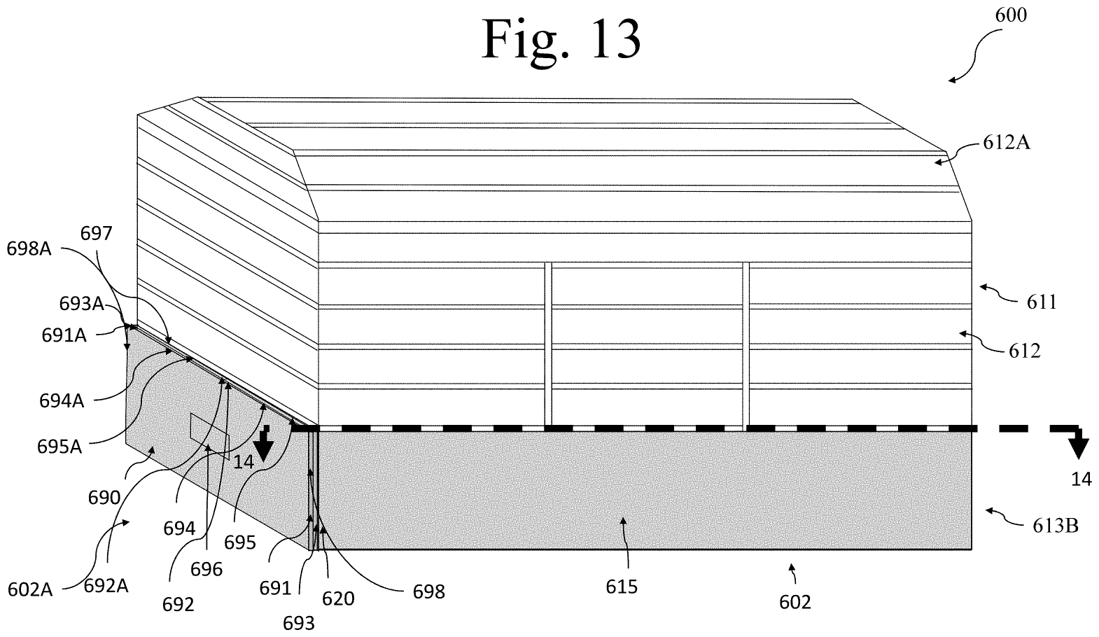

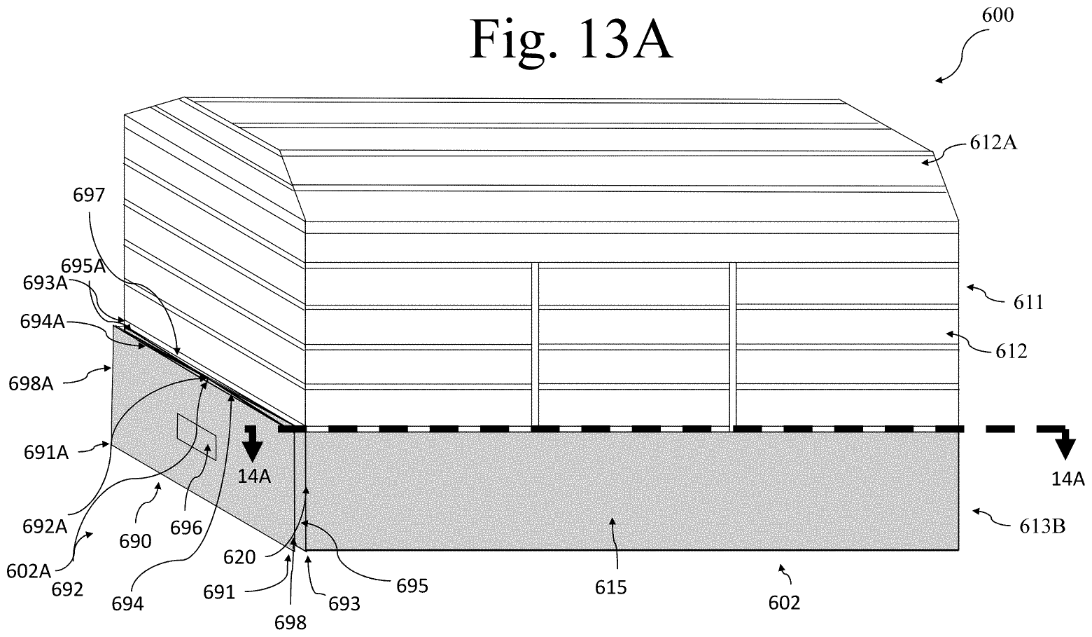

Referring to the first to the fourth embodiments, the invention focuses on the modifications made to the bottom and sidewalls of the lower base member. As a result, the upper cage member can be in any known shape or form. For example, the pet cage in accordance with the present invention may have a more modern design 500 shown in FIG. 12, which Cinnamon lives in. In this design, the cage has an upper cage member 511 comprising a plurality of sidewalls forming an enclosure 512 and a lid 512A. The lid 512A has a generally trapezoidal or semi-circular cross section and is rotatably attached to the upper perimeter of a sidewall by hinges. The cage further has a lower base member 513 showing a side opening 546A immediately adjacent to the bottom of the lower base member.

In the first to the fourth embodiments, the invention also contemplates a design where the use of an exchangeable plate with access points, or an exchangeable tray with a bottom plate having access points, is entirely avoided. In this case, an exchangeable plate without any access point or an exchangeable tray with a bottom plate having no access points are used when the pet is indoors, and are removed without replacement when the pet is placed outdoors for grass feeding. In this design, the opening 48, 148, 248, 348, or 448 are the access points. However, this design is disfavored due to the absence of structural support provided by an exchangeable plate or exchangeable tray, and the risk of the pet falling out of or escaping from the opening during transport.

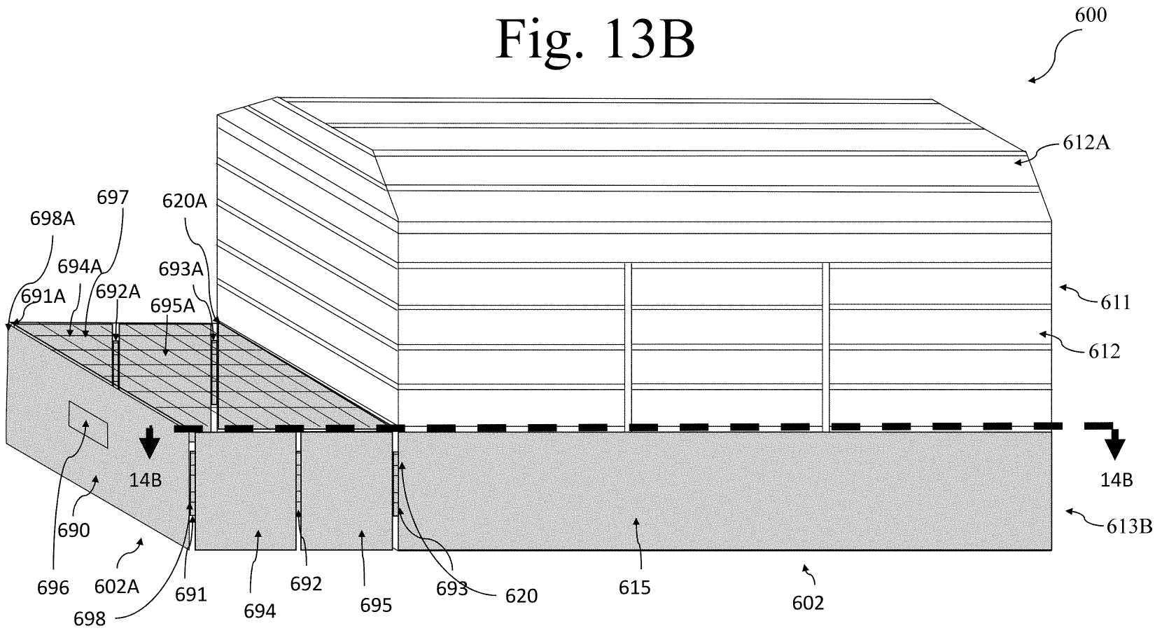

The fifth embodiment, as illustrated in FIGS. 13 through 19, is directed to a construction that has at least two portions for its base member: a fixed portion and one or more adjustable portions that can be extended or collapsed as needed. Instead of providing access points at the bottom surface of the base member, which is essentially the fixed portion in its entirety, as described in the preceding embodiments, or in addition to such access points that are located in the fixed portion, access points are provided by one or more adjustable portions that are located adjacent, and attached to, one or more sides of the fixed portion of the base member. As described below, each of the adjustable portions can alternate between a fully extended, partially extended, and fully collapsed state. The adjustable portions have fully open or partially open bottoms. When in a partially or fully extended state, access to grass is provided through the opening in the bottoms of the adjustable portions.

As illustrated in FIGS. 13, 13A and 13B, which are perspective views of the pet cage in accordance with the fifth embodiment wherein the adjustable portion is in a fully collapsed state, partially collapsed state and a fully extended state, respectively, the pet cage 600 comprises (i) an upper cage member 611, which comprises an enclosure 612 and a lid 612A, (ii) a base member 613B, which comprises a fixed portion 602 and one or more adjustable portions 602A.

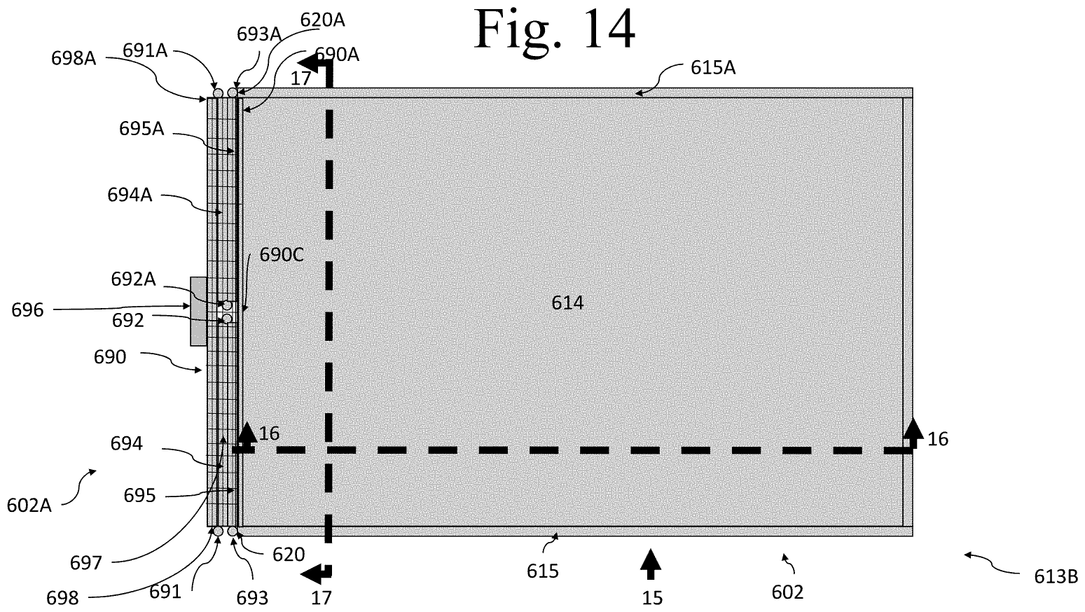

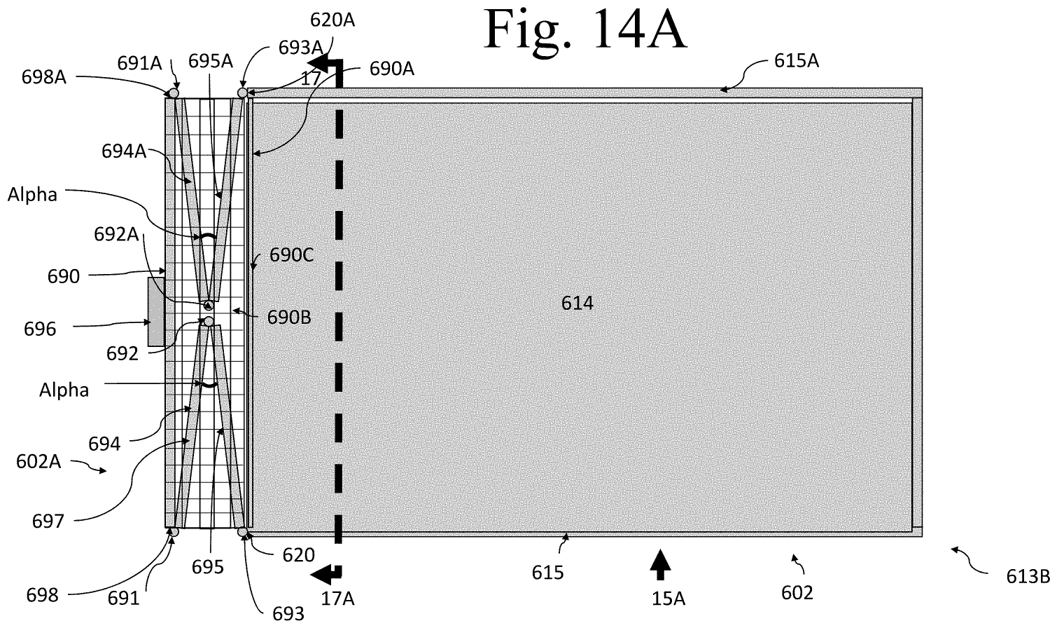

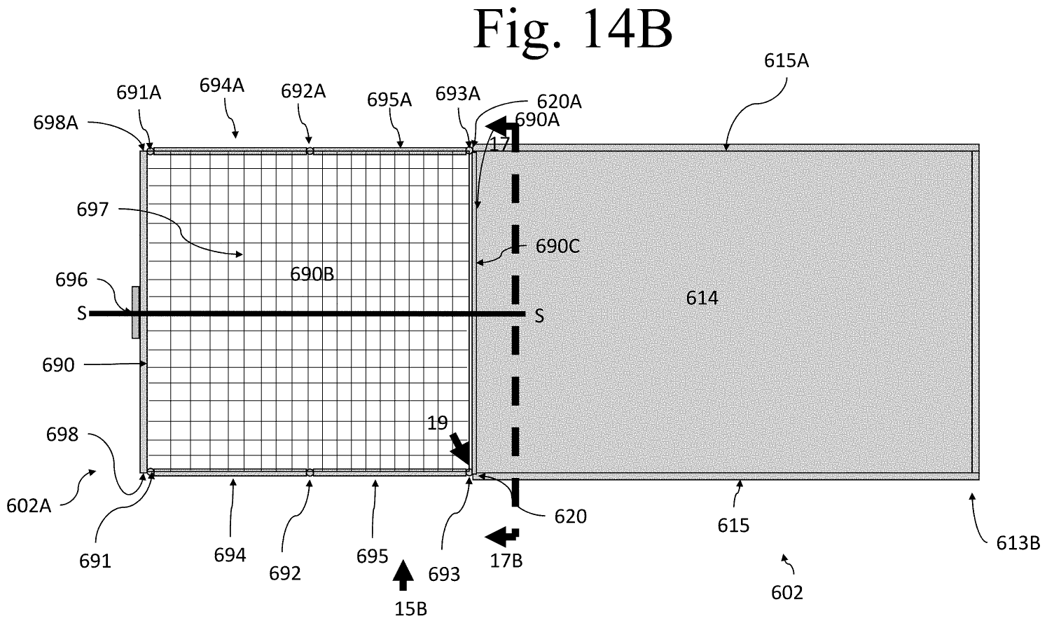

FIGS. 14, 14A, and 14B, are respectively a top view of the lower base member along (i) the cut line 14-14 in FIG. 13, (ii) the cut line 14A-14A in FIG. 13A, and (iii) the cut line 14B-14B in FIG. 13B. As best illustrated in FIGS. 14, 14A, and 14B, the fixed portion 602 is fixed in its shape and size and comprises a bottom member 614 and multiple sidewalls arranged in serial to form an enclosed structure except for an opening 690C on one side (or more than one side if more than one adjustable portion is desired). While the fixed portion 602 is shown to have 4 sides in FIGS. 13 to 19, it may have 3, 5, or more sides.

The fixed portion 602 serves as the permanent activity space for the pet, and is available at all times for the pet to roam around, play and feed in. Consistent with its role as the permanent activity space, bedding material can be provided on the bottom member 614. The fixed portion 602 may further contain (i) one or more openings in the bottom member of the lower base portion, such as the ones identified by 48, 148, 248, 348, 448, and (ii) the opening in one or two opposing sidewalls, such as the ones identified by 46A, 46B, 146A, 446A, 446B, 546A, as described in any of the preceding embodiment, which are arranged to accommodate one or more exchangeable plate or exchangeable tray in the same manner as described earlier.

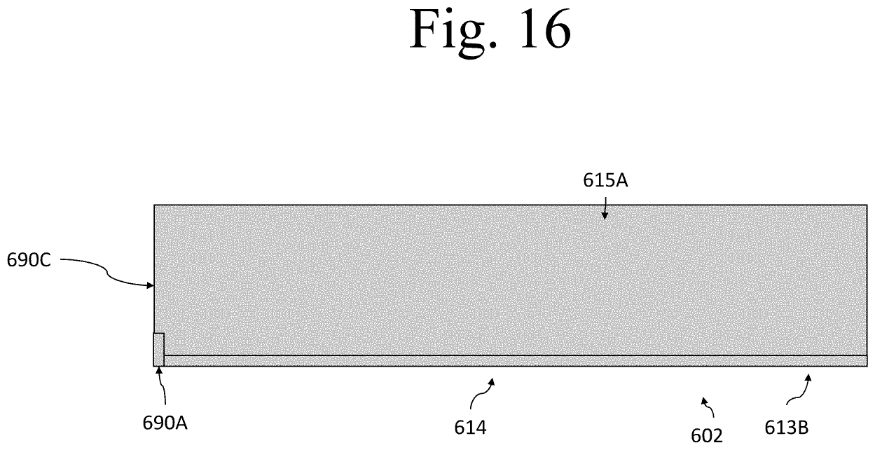

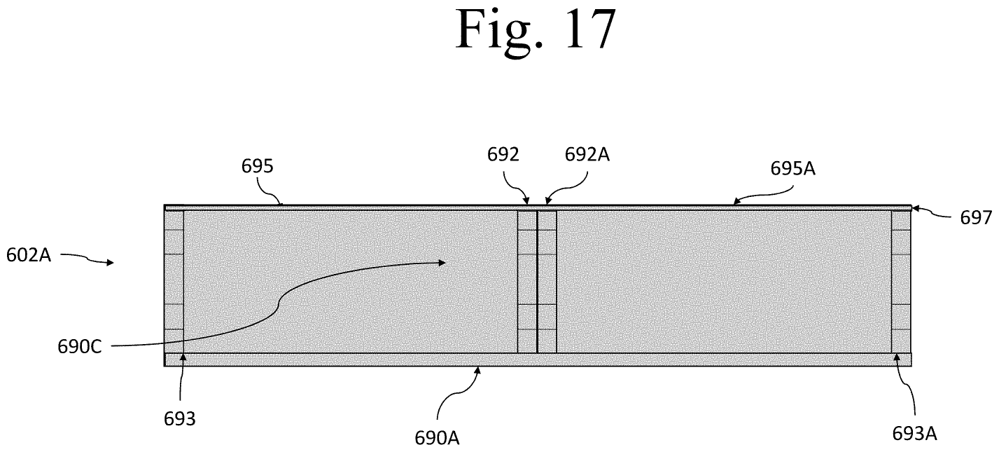

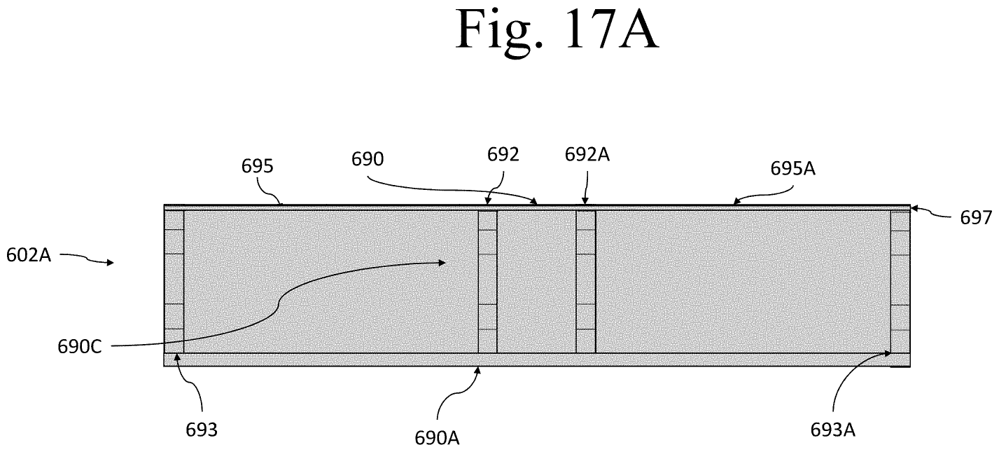

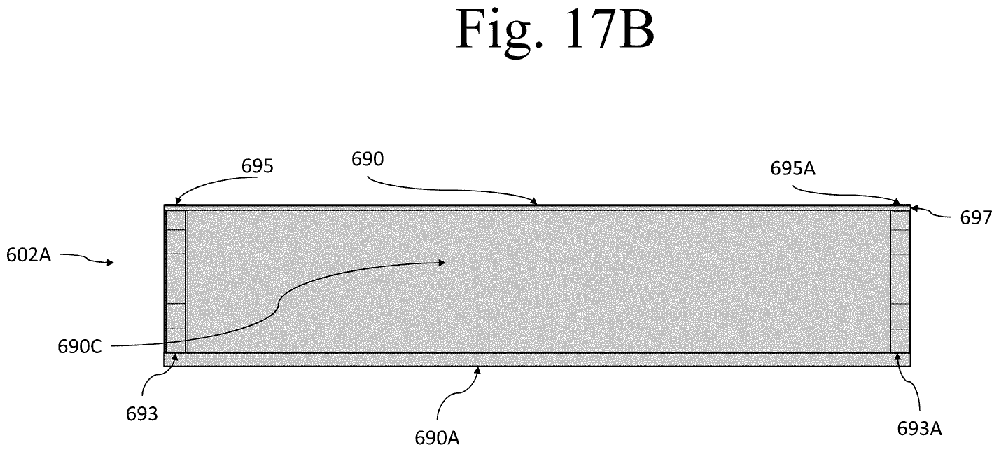

At the side opening 690C in the fixed portion 602, a lip 690A replaces a sidewall that would otherwise be present to form a complete enclosed structure as shown in the preceding embodiments (see e.g. FIG. 2). As best seen in FIG. 16, which is a cross-sectional view of the fixed portion 602 along the cut line 16-16 in FIG. 14, as well as FIG. 17, which is a side view of the adjustable portion of the base member viewed from a cross-sectional line 17-17 in the fixed portion of the base member as shown in FIG. 14, the lip 690A is low in height (preferably 1-3 inches arising from the bottom member 614) when compared to a sidewall in order to provide access for the pet to move between the fixed portion and the adjustable portion and at the same time, is high enough to keep the bedding material in the fixed portion from falling off the bottom member 614 into the adjustable portion.

As seen in FIGS. 14, 14A and 14B, the lip 690A is located between two opposing sidewalls 615 and 615A, and is the low barrier between the fixed portion 602 and the adjustable portion 602A. The length of the lip 690A runs the entire gap between the opposing sidewalls 615 and 615A. The opposing sidewalls 615 and 615A have side edges 620 and 620A, respectively, both of which run substantially perpendicular to the length direction of the lip 690A. Together with the lip 690A, the side edges 620 and 620A define the opening 690C.

As illustrated in FIGS. 13, 13A and 13B, the adjustable portion 602A comprises an end wall 690, and two foldable pairs of wall segments, i.e., the pair 694/695 and the pair 694A/695A. As described in more detail below, the foldable pairs of wall segments may open or close to change the space contained by the adjustable portion 602A while serving to connect the end wall 690 to the fixed portion 602.

The end wall 690 has two edges 698 and 698A, which together define the length of the end wall 690 therebetween. The length of the end wall 690 is substantially the same as the length of the lip 690A. For example, in FIG. 14A, the length of end wall 690 is substantially equal to the gap between the opposing walls 615 and 615A, which, as described above, is also the length of the lip 690A.

Preferably, the end wall 690 has a height that is substantially the same as the height of any other sidewalls of the base member 613B. The end wall is preferably 5 inches in height, 0.5 inches in thickness, and substantially equal in length to the lip 690A.

Regardless whether the adjustable portion is in the the extended or collapsed state, the end wall 690 serves as an end wall for the base member 613B. In the collapsed state, the edge 698 of the end wall 690 is located adjacent, and runs parallel, to the edge 620 of the enclosure, and the edge 698A of the end wall 690 is located adjacent, and runs parallel, to the edge 620A of the enclosure.

The end wall 690 may also have a plate (not shown in any figures) extending horizontally at its bottom in the direction of the lip 690A, creating an “L”-shaped cross section with the end wall 690 being the upright portion and the plate being the horizontal portion. This plate serves to limit the amount of opening at the bottom of the adjustable portion 602A when the adjustable portion 602A is in a partially or fully extended state, and also provides additional structural strength to the end wall 690. This plate extends in a length direction the entire length of the end wall 690, and preferably 0.5 to 3 inches in a width direction. The parts can be dimensioned such that when in a fully collapsed state, the plate is located immediately above the lip 690A or under the bottom (614) of the fixed portion 602.

The foldable pairs of wall segments are arranged between, and are the intermediary for connecting the end wall 690 and the fixed portion 602. Each pair comprises two wall segments of substantially identical shape and size (preferably rectangular or square), which are joined to each other along a common edge and may rotate relative to each other from an open-and-apart state (i.e., 180 degrees between the pair as shown in FIG. 14B) to an overlapping state (i.e., substantially 0 degree between the pair as shown in FIG. 14) through an infinite number of intervening states (represented by FIG. 14A). For example, the foldable pair of wall segments 694 and 695 are joined to each other along a common edge and may rotate relative to each other around an axis 692 that is located at the common edge. Similarly, the foldable pair of wall segments 694A and 695A are joined to each other along a common edge and may rotate relative to each other around an axis 692A that is located at the common edge. Axes 692 and 692A may be provided using any conventional means that may impart rotation, such as a hinge.

Preferably, the wall segments 694, 694A, 695 and 695A each have a height and width that is substantially the same as the height of any other sidewalls of the base member 613B. The wall segments preferably have a length that is 40-49% of the length of the lip 690A, and a preferred height of 5 inches and a preferred thickness of 0.5 inches.

In addition to the common edge where the pair of wall segments are connected to each other, each wall segment has a far edge that is opposite from the common edge. The far edges are for connecting the pair of wall segments to the end wall 690 on one end and the fixed portion of the base member on the other end. For example, as best seen in FIGS. 14, 14A and 14B, the pair of wall segments 694/695 has two far edges, one being the far edge located on the wall segment 694 and rotatably connected to the edge 698 of the end wall 690 around an axis 691, and the other being the far edge located on the wall segment 695 and rotatably connected to the side edge 620 of the sidewall 615 around an axis 693. The axes 691 and 691A, and 693 and 693A may be provided using any conventional means that may impart rotation, such as a hinge. Similarly, as best seen in FIGS. 14, 14A and 14B, the pair of wall segments 694A/695A has two far edges, one being the far edge located on the wall segment 694A and rotatably connected to the edge 698A of the end wall 690A around an axis 691A, and the other being the far edge located on the wall segment 695A and rotatably connected to the side edge 620A of the sidewall 615A around an axis 693A.

As best seen in FIG. 14, in a fully collapsed state, the wall segments 694 and 695 fully or substantially fully overlap on to each other, having an angle about 0 degrees therebetween at the axis 692. Similarly, the wall segments 694A and 695A fully or substantially fully overlap on to each other, having an angle about 0 degrees therebetween at the axis 692A.

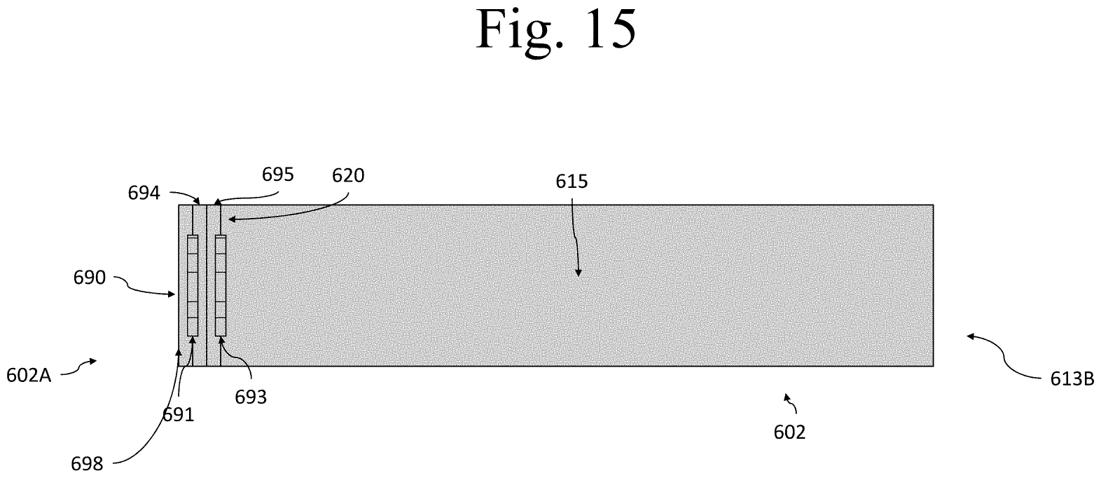

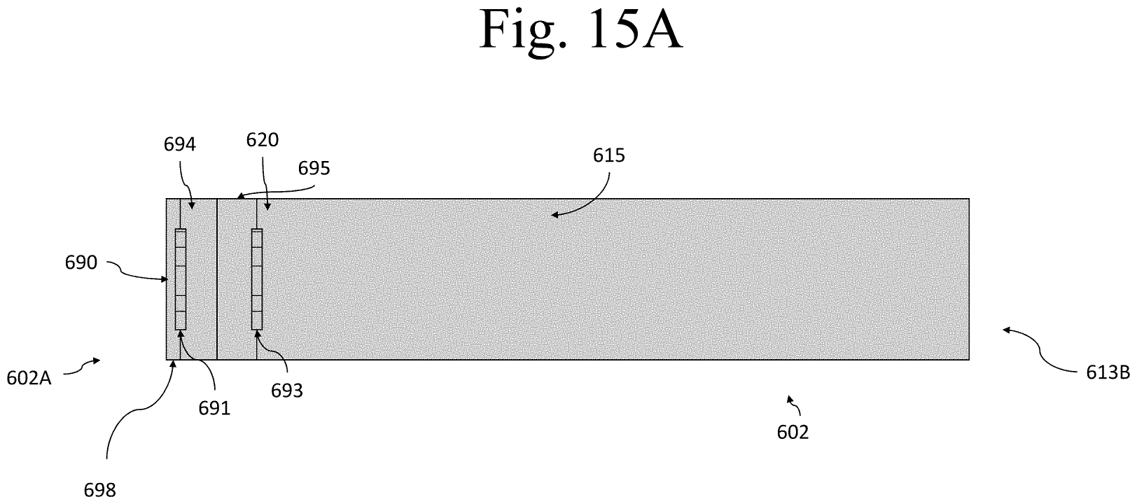

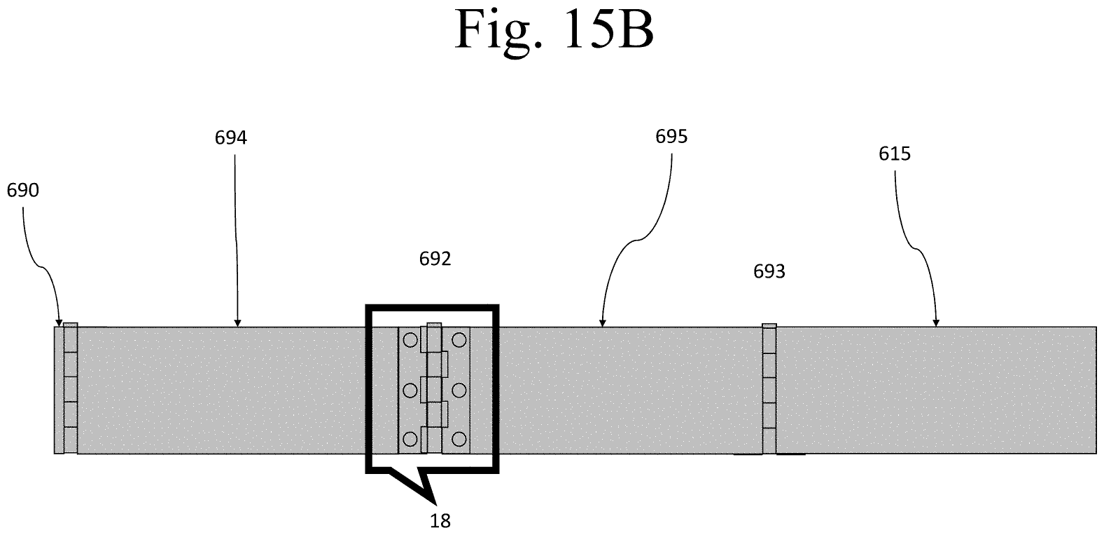

In the corresponding front view of the lower base member, as shown in FIG. 15, the axes 691 and 693 (shown in the form of hinges) are located close to each other and separated only by the combined thickness of the pair of wall segments 694 and 695. The end wall 690 is at 0° from wall segments 694 and 694A. The angle measurement between the front wall 615 and wall segment 695, and the angle between the front wall 615A and wall segment 695A, are determined by the equation [180×(n−2)]÷n, where the variable n is the number of sides of the base member 613B. In FIGS. 13 to 19, where the fixed portion 602 is shown to be a 4-sided structure, the angles created by the front wall 615 and wall segment 695, and the back wall 615A and wall segment 695A, are both 90°.

In FIG. 17, which is a side view of the adjustable portion of the base member viewed from a cross-sectional line 17-17 in the fixed portion of the base member as shown in FIG. 14, the wall segments 695 and 695A and the axes 692 and 692A combine to completely or substantially fill the opening 690C in the enclosed structure of the fixed portion 602. In this configuration, the axes 692 and 692A are touching or substantially touching each other. The wall segments 694, 694A, 695 and 695A, the end wall 690, and the lip 690A are substantially parallel to one another in their length directions.

When the adjustable portion is expanded from the collapsed state toward the fully extended state, the pair of wall segments 694 and 695 rotate toward an increasingly open-and-apart state, in which the pair remains connected at their common edges around axis 692 but is increasingly farther apart between the far edges. Similarly, the pair of wall segments 694A and 695A rotate toward an increasingly open-and-apart state, in which the pair remains connected at their common edges around axis 692A but is increasingly farther apart between the far edges. During this continuum from the collapsed state toward the fully extended state, because the far edges of the pair of wall segments remain connected to an edge of the end wall 690 or a side edge of the sidewall 615 (or 615A), the opening motion of each pair of wall segments causes the axes 692 and 692A to retract away from the center of the adjustable portion 602A, creating an open space between 692 and 692A. The retraction of 692 and 692A from each other is also seen in FIG. 17A. Simultaneously, the wall segments move away from the end wall 690 and the lip 690A to create an open space between these members. Namely, the wall segment 694 rotates away from the end wall 690 around the axis 691 to create a space between the wall segment 694 and the end wall 690, the wall segment 694A rotates away from the end wall 690 around the axis 691A to create a space between the wall segment 694A and the end wall 690, the wall segment 695 rotates away from the lip 690A around the axis 693 to create a space between the wall segment 695 and the lip 690A, and the the wall segment 695A rotates away from the lip 690A around the axis 693A to create a space between the wall segment 695A and the lip 690A. During this continuum of motion, the end wall 690 is gradually removed from, but remains parallel to, the lip 690A. The concerted motion by the pairs of wall segments 694, 695, 694A, 695A, the end wall 690 and the lip 690A leads to the formation and enlargement of a continuous open space 690B. Open space 690B has a fully or partially open bottom, which provides the pet access to grass on a lawn.

FIG. 14A is effectively a representative and a snapshot in the continuum from the collapsed state to the fully extended state. In FIG. 14A, the pair of wall segments 694 and 695 rotate around the axis 692 and form an angle “Alpha” between the two segments. Similarly, the pair of wall segments 694A and 695A rotate around the axis 692A and form an angle “Alpha” between the two segments. As is obvious from the use of the same notation “Alpha”, the two angles are congruent and remain congruent as they increase from 0 to 180 degrees as the adjustable portion transitions from the collapsed state to the fully extended state. In the snapshot shown in FIG. 14A, the wall segments 694 and 694A are at an angle of Alpha/2 from the end wall 690. Similarly, the wall segments 695 and 695A are at an angle of Alpha/2 from the lip 690A. These two angles are also congruent and remain congruent during the transition of states.

In the front view (FIG. 15A) that corresponds to FIG. 14A, the axes 691 and 693, again shown as hinges, are further apart than in the fully collapsed state. The distance between the axes 691 and 693 is substantially defined by simple geometry, i.e., 2×length of each wall segment×sin(Alpha/2).

The transition from a collapsed state to an extended state can be facilitated by the inclusion of a handle 696 on the end wall 690. When a user pulls on the handle 696 in the direction of extending the adjustable portion 602A, the adjustable portion 602A extends. When a user pushes on the handle 696, or another part of the end wall 690, in the direction of collapsing the adjustable portion 602A, the adjustable portion 602A collapses.

As best seen in FIG. 14B, in a fully extended state, the wall segments 694 and 695 are completely or substantially fully open and apart from each other, having an angle about 180 degrees therebetween at the axis 692. The wall segments 694 and 695 are collinear to each other. Similarly, the wall segments 694A and 695A are fully or substantially fully open and apart from each other, having an angle about 180 degrees therebetween at the axis 692A. The wall segments 694A and 695A are collinear to each other. The axes 692 and 692A are located far apart from each other and are separated by the full length of the lip 690A. The wall segments 694 and 694A are at a right angle or substantially at a right angle to the end wall 690. The wall segments 695 and 695A are at a right angle or substantially a right angle to the lip 690A.

In the corresponding front view of the lower base member, as shown in FIG. 15B, the axes 691 and 693 (shown in the form of hinges) are located far apart from each other and separated substantially by the combined lengths of the wall segments 694 and 695.

In FIG. 17B, which is the side view of the adjustable portion 602A viewed from a cross-sectional line 17B-17B in the fixed portion of the base member as shown in FIG. 14B, the wall segments 694, 694A, 695, and 695A are fully retracted and form the sides of the adjustable portion 602A. The inner side of the end wall 690 is fully in view and serves to fill in the opening 690C in the enclosed structure of the fixed portion of the lower base member.

In this fully extended state, the open space 690B is enclosed by the end wall 690, wall segments 694, 695, 694A, 695A, and the lip 690A. The open space 690B is at its maximum value. The open space 690B has a fully open or partially open bottom, which provides the pet access to grass on the lawn.

The hinges used in this fifth embodiment can be any of the known hinges. Examples include Rockler Woodworking and Hardware Butt Hinge (item no. #44018), Everbilt hinges (model nos. 13654, 14449, 14874, 14979, 14981, 14985, 15002, 15029, 16909, 19092, 20094, 20175, 20600, 20114, 20164, 20284, 20605), Crown Bolt (model nos. 14982, 15031, 15065, 15409, 15411, 15494, 16115, 16123, 18105, 18107, 18114, 20824), Dynasty Hardware hinges (model nos. SP-40-58-US15-2PK), National Hardware hinges (model nos. N148-585, N241-190), Murphy Door hinges (model no. FMHD), SOSS hinges (model no. 218US26D), and hinges of similar designs by the above-mentioned suppliers as well as other suppliers. The hinges used in this invention can be made of brass, nickel, plastic, or other desired materials. These hinges also utilize holes in the hinge plates, to accept a fastener, which effectively connects the hinges to each of the part such as 620, 620A, 690, 694, 694A, 695 and 695A.

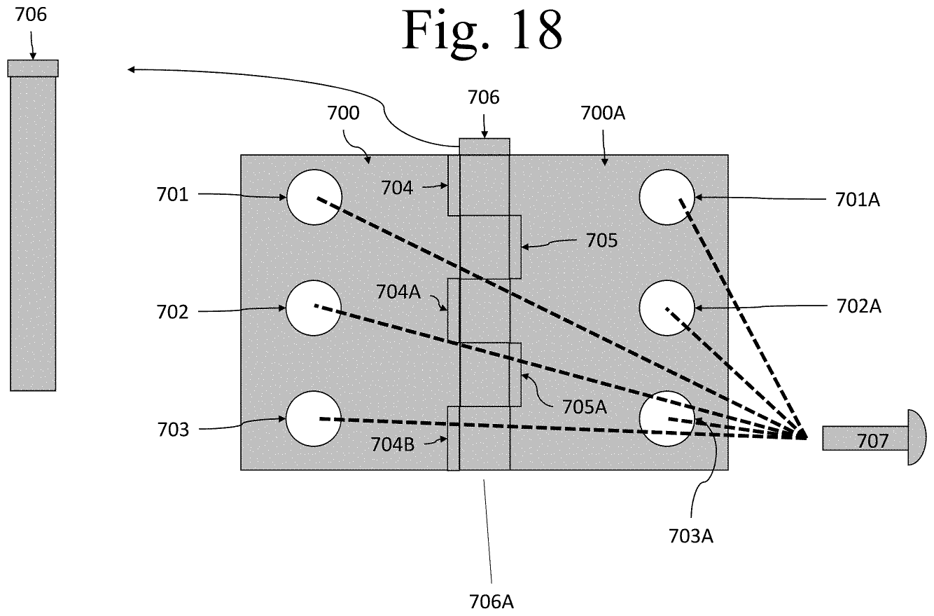

As illustrated in FIG. 18, conventional butt hinges 691, 692, 693, 691A, 692A, and 693A, can be used to provide an axis. Each hinge comprises two hinge plates, which are connected to intertwining sleeves (also known as tubular sections). A first hinge plate 700 is connected to sleeves 704, 704A, and 704B. The hinge plate 700 has holes 701, 702, and 703 to accept fasteners, such as a fastener 707. A second hinge plate 700A is connected to sleeves 705 and 705A, which are preferably equal in dimensions to the sleeves 704, 704A, and 704B, and fit within the gaps created amongst the three sleeves. When the pin 706 is placed through sleeves 704, 705, 704A, 705A, and 705B, the sleeves are fixed in a collinear arrangement and the hinge plates 700 and 700A can rotate relative to each other along the common longitudinal axis 706A. The gap between the sleeves 705 and 705A is equal in dimensions to the dimensions of the sleeve 704A. The gap between the sleeves 704 and 704A are equal in dimensions to the dimensions of the sleeve 705. The gap between the sleeves 704A and 704B are equal in dimensions to the dimensions of the sleeve 705A. Since the dimensions are all equal to each other, the sleeves fit together, where the bottom of the sleeve 704 touches the top of the sleeve 705, the bottom of the sleeve 705 touches the top of the sleeve 704A, the bottom of the sleeve 704A touches the top of the sleeve 705A, and the bottom of the sleeve 705A touches the top of the sleeve 704A. When the pin 706 is placed into the sleeves 704, 704A, 704B, 705, and 705A, the sleeves are all locked into one line, creating an assembly of rotating hinge plates.

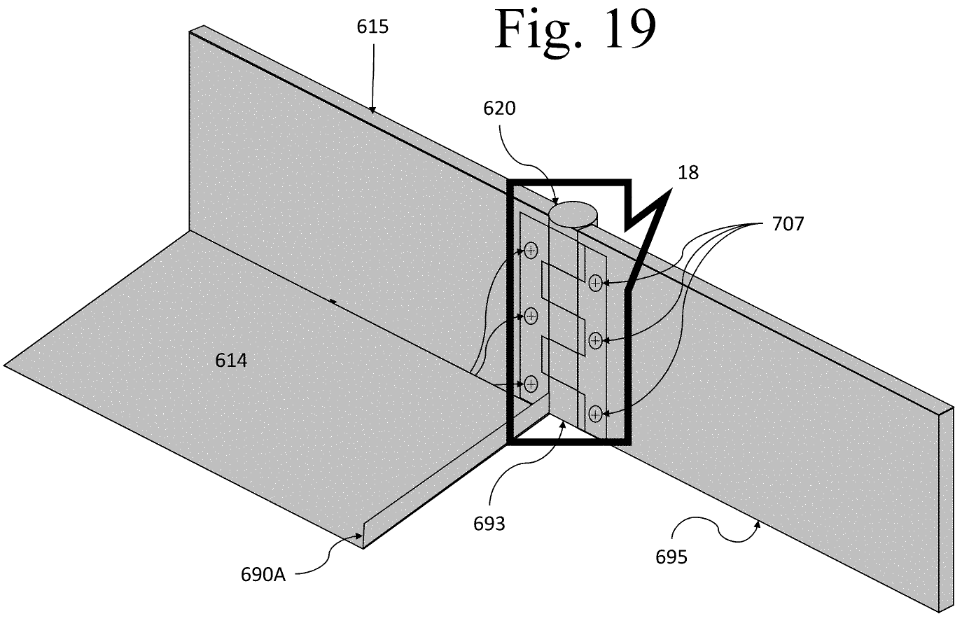

FIG. 19 is a view of the hinge 693 and surrounding members as indicated by 19 in FIG. 14B. As illustrated in FIG. 19, a hinge, such as one shown in FIG. 18, is used to connect wall segment 695 to front wall 615. Hinge plate 700 is fastened to the inner side of the front wall 615 using fasteners 707. Hinge plate 700A is fastened to the inner side of the wall segment 695 using fasteners 707. These two hinge plates are connected among a common axis, which is created when the pin 706 is inserted into the sleeves, or tubular sections: 704, 704A, 704B, 705, and 705A, when the sleeves are collinear. When the hinge is fastened in this manner, the sleeves, or tubular sections, 704, 704A, and 704B are adjacent to and touching the edge 620 of the front wall 615, and wall segment 695 can rotate relative to the front wall 615.

The hinge 691 preferably has its hinge plates attached to the insides of the end wall 690 and wall segment 694.

As can be understood from the drawings, the adjustable portion 602A preferably has at least one axis of symmetry, as shown by S-S in FIG. 14B. The halves below and above the S-S axis are substantially identically structured, including how the hinges are attached to the wall segments, the end wall segment 690 and the opposing front walls 615 and 615A.

Preferably, a net 697 is provided and connected to the top of the end wall 690 and the top of the edges 620 and 620A, to ensure that the pet does not jump out of the enclosure of the adjustable portion when the adjustable portion 602A is in a partially or fully extended state.

The net 697 is preferably a permanent installation between the top of the edges 620 and 620A, and the top of the end wall 690. In this configuration, the net 697 may be made of a non-stretchable or stretchable material.

If a non-stretchable material is used, the net 697 is made to be large enough to cover the entire top of the adjustable portion 602A in a fully extended state. When the adjustable portion 602A is fully or partially collapsed, the net 697 will hang loose between the end wall 690 and the top of the edges 620 and 620A. When the adjustable portion is fully extended, the net 697 is fully extended. Materials suitable for making a non-stretchable net 697 can be any filament or fiber known in the art, such as natural yarn or a polymeric material, including but not limited to, polyolefins, acrylics, epoxies, polyamide-imides, polyesters, polyesteramides, polyamides, polyimides, polysulfones and polyurethanes and co-polymers thereof. Examples of polymer filaments are disclosed in numerous patents and patent applications, including EP0506983A1 to Masuda, EP0618985B1 to Bhoori, EP1054085B1 to Kanamori, DE19580248C5 to Horii, WO1995027818A1 to Ballard, US20090075543A1 to Zhang, the disclosure of which are incorporated herein.

If a stretchable material is used, the net 697 is permanently attached to the top of the end wall 690A. When the adjustable portion 602A moves from a fully collapsed state into a fully extended state, the net 697 stretches in sync to the adjustable portion 602A, to keep the top closed at all times. Materials suitable for making a stretchable net 697 can be any elastic filament or fiber known in the art, such as natural rubber, plasticized polyvinyl chloride, low density polyethylene, thermoplastic rubber, ethylene-ethyl acrylate, ethylene-butylene copolymer, polybutylene and copolymers thereof, ethylene-propylene copolymers, chlorinated propylene, chlorinated polybutylene or mixtures of those, polyurethane elastomeric materials, polyester elastomeric materials, polyamide elastomeric materials, copolymers of isobutylene and isoprene, and additional materials disclosed in U.S. Pat. No. 4,425,393 to Benedyk, U.S. Pat. No. 4,874,447 to Hazelton, U.S. Pat. No. 4,657,802 to Morman, U.S. Pat. No. 4,833,012 to Makimura, U.S. Pat. No. 4,820,572 to Killian, U.S. Pat. No. 4,803,117 (Daponte), U.S. Pat. No. 4,940,464 to Van Gompel, U.S. Pat. No. 4,938,757 to Van Gompel, U.S. Pat. No. 4,938,753 to Van Gompel, and U.S. Pat. No. 6,140,442 to Knight, the disclosure of which are incorporated herein.

When the pet is kept indoors, the adjustable portion 602A is in a fully collapsed state, so that the pet only lives in the fixed portion 602, which has a bedding material. When the pet is to be fed with fresh grass on a lawn, the pet cage is moved outdoors and rested on a lawn, and the adjustable portion 602A is transitioned into a partially or, more preferably, a fully open state, exposing the partially or fully open bottom underneath the adjustable portion 602A. The pet then may migrate from the fixed portion 602 to the adjustable portion 602A to access fresh grass. Once feeding is completed, the pet is directed to return to the fixed portion 602 and the adjustable portion 602A is returned to the fully collapsed state.

The adjustable portion is not only limited to the use of feeding, but may also be used to conveniently clean bedding from the cage. When the cage is to be cleaned, the adjustable portion 602A is transitioned into a partially or, more preferably, a fully open state. The pet then may migrate from the fixed portion 602 to the adjustable portion 602A to temporarily make it more convenient to clean the bedding in the cage, without interference from the pet. Once cleaning is completed, the pet is directed to return to the fixed portion 602 and the adjustable portion 602A is returned to the fully collapsed state.

While the figures described herein for the fifth embodiment are substantially based on the fourth embodiment, and represents a modern construction of pet cages, this invention is not limited to such construction. For example, the pet cage in accordance with the fifth embodiment can comprise an upper cage member and a lower base member as described in any of the preceding embodiments. One example would be the first embodiment, wherein the enclosure and lid are effectively incorporated into the upper cage member and/or the base member.

While only one adjustable portion is illustrated in FIGS. 13 to 19, the base member may have one or more additional adjustable portions of similar construction, each matching the shape and size of the sidewall of the lower member to which the additional adjustable portion is adjacent to. If desired, additional adjustable portions may be added to the fixed portion by converting one wall to a lip and connecting an adjustable portion with a construction as described above.

In all the preceding embodiments, all parts of the cage, including the parts of the adjustable portion 602A, can be made of any suitable materials, such as a metal, a plastic, or a metal coated with plastic. Examples of suitable metal materials include aluminum, copper, brass, steel, and stainless steel, and the metal parts may be further galvanized. Suitable plastics for making these parts or coating metal parts are well known in the art, and examples include polyolefins, acrylics, epoxies, polyamide-imides, polyesters, polyesteramides, polyamides, polyimides, polysulfones and polyurethanes and co-polymers thereof, such as those described U.S. Pat. No. 3,617,364 to Jarema, U.S. Pat. No. 3,829,545 to Van Vlaenderen, U.S. Pat. No. 3,893,642 to Van Vlaenderen, U.S. Pat. No. 4,521,363 to Vogel, U.S. Pat. No. 4,541,980 to Kiersarsky, U.S. Patent Application Publication No. 20080193755 to Guise, which are incorporated herein by reference. Particularly preferred polymer materials include polyethylene, polypropylene, polycarbonates, polyethylene terephthalate, polyacrylates (e.g., poly(methyl methacrylate)), acrylonitrile butadiene styrene (ABS) and polyvinyl chloride. The wires are preferably metal coated with a plastic. The lower base member, the exchangeable plates, and the exchangeable trays are preferably formed entirely of a plastic.

Although the invention has been described in conjunction with preferred forms thereof, it will be appreciated by those skilled in the art, that additions, modifications, substitutions, and deletions may be made without departing from the spirit or scope of the invention as defined in the appended claims.

1-17. (canceled)

18. A pet cage comprising:
an upper cage member; and
a lower cage member comprising:
a fixed portion and one or more adjustable portions,
wherein said one or more adjustable portions have a partially or fully open bottom.

19. A pet cage of claim 18, wherein said fixed portion has a partially open bottom.

20. A pet cage of claim 18, wherein said fixed portion has a bottom plate, wherein the bottom plate has a lip disposed adjacent to each of said one or more adjustable portions.

21. A pet cage of claim 18, wherein each of said one or more adjustable portions has an end wall and at least one pair of foldable wall segments.

22. A pet cage of claim 21, wherein said at least one pairs of foldable wall segments are connected by hinges.

23. A pet cage of claim 18, wherein each of said one or more adjustable portions has an end wall that has a horizontally extending bottom plate.

24. A pet cage comprising
an upper cage member; and
a lower cage member comprising a fixed portion defining a first activity space and one or more adjustable portions,
wherein each of said one or more adjustable portions is adapted for alternating between at least one extended state and a collapsed state,
wherein each of said one or more adjustable portions has an end wall and at least one pair of foldable wall segments, said end wall and said at least one pair of foldable wall segments are connected by hinges, and said end wall has a horizontally extending bottom plate,
wherein in the at least one extended state, each of said one or more adjustable portions defines an auxiliary activity space and has a partially or fully open bottom,
wherein the first activity space and each of the one or more auxiliary spaces are in open communication with one another.

25. A pet cage comprising
an upper cage member; and
a lower cage member comprising a fixed portion defining a first activity space and one or more adjustable portions,
wherein each of the one or more adjustable portions is adapted for alternating between at least one extended state and a collapsed state,
wherein in the at least one extended state, each of the one or more adjustable portions defines an auxiliary activity space and has a partially or fully open bottom,
wherein the first activity space and each of the one or more auxiliary spaces are in open communication with one another.

26. A pet cage of claim 25, wherein said fixed portion has a partially open bottom.

27. A pet cage of claim 25, wherein said fixed portion has a lip at each end of the bottom plate that is adjacent to each of said one or more adjustable portions.

28. A pet cage of claim 25, wherein each of said one or more adjustable portions has an end wall and at least one pair of foldable wall segments.

29. A pet cage of claim 25, wherein each of said one or more adjustable portions has an end wall that has a horizontally extending bottom plate.

30. A pet cage of claim 29, wherein said at least one pairs of foldable wall segments are connected by hinges.

31. A pet cage of claim 25, wherein each of said one or more adjustable portions has a stretchable net defining the upper limit to each said auxiliary activity space.
